(19) United States
(12) Patent Application Publication
(10) Pub. No.: US 2026/0278021 A1
(43) Pub. Date: Sep. 17, 2026

(54) PROVIDING INTELLIGENT SEARCH FUNCTIONALITY OF A CODE REPOSITORY VIA AN AUTONOMOUS SOFTWARE AGENT

(71) Applicant: COGNITION AI, INC., San Francisco, CA (US)

(72) Inventors: Mokshit Jain, New Delhi (IN); Gennady Korotkevich, Menlo Park, CA (US); Adhyyan Sekhsaria, San Francisco, CA (US); Jacob Teo, Redwood City, CA (US)

(21) Appl. No.: 19/224,222

(22) Filed: May 30, 2025

Related U.S. Application Data
(60) Provisional application No. 63/770,816, filed on Mar. 12, 2025.

(51) Int. Cl. G06F 16/9538; G06F 8/33; G06F 8/70; G06F 16/951

(52) U.S. Cl. CPC G06F 16/9538; G06F 8/33; G06F 8/70; G06F 16/951

(57) ABSTRACT

The present disclosure relates to systems, methods, and non-transitory computer-readable media that generates a response to a prompt by an autonomous software agent system using an index of one or more code repositories. In particular, the disclosed systems generate an index of one or more code repositories available to the autonomous software agent system. Moreover, the disclosed systems provide an intelligent search interface to query the autonomous software agent system about the one or more code repositories. Additionally, the disclosed systems receive a prompt via the intelligent search interface and generate a response to the prompt and source information from the one or more code repositories supporting the response to provide for display in the intelligent search interface.

### CROSS REFERENCE TO RELATED APPLICATIONS

This application claims the benefit of and priority to U.S. Provisional Application No. 63/770,816, filed Mar. 12, 2025. The aforementioned application is hereby incorporated by reference in its entirety.

### BACKGROUND

Advancements in computing devices and networking technology have given rise to a variety of innovations in machine learning and digital assistants. Over time, computing systems have been developed that generate computer code to assist a developer in completing their computer tasks. For instance, some existing systems can assist software developers in generating code by supplementing/modifying existing computer code and using the generated computer code to bolster their codebase. Despite these advances, however, existing systems continue to suffer from a number of disadvantages, particularly in terms of efficiency, accuracy, flexibility, and security.

### SUMMARY

One or more embodiments described herein provide benefits and/or solve one or more problems in the art with systems, methods, and non-transitory computer-readable media that generate intelligent responses to prompts related to a code repository available to an autonomous software agent system. To illustrate, in some embodiments, the disclosed systems receive a prompt with a question regarding computer code in a code repository and the disclosed systems generate a response with supporting sources (e.g., code snippets and file paths) that underpin the response. In some embodiments, via allowing a user of a computing device to submit prompts pertinent to a code repository (e.g., a prompt to search for computer code and/or a prompt to search for potential issues in the code repository, such as diagnosing computer code bugs), the disclosed systems pull together relevant context for a specific software coding task and/or diagnose a potential issue in the code repository and deploy an autonomous software agent to work on the specific software task.

In other words, the disclosed systems can use artificial intelligence models to reason about the quality of computer code in a code repository and identify computer code that is potentially causing issues. In doing so, the disclosed systems improve how computer code generated by an autonomous software agent is successfully merged and deployed on a code repository. In particular, the disclosed systems receive a prompt, generate a response to the prompt (e.g., by the autonomous software agent system using an index of the code repository), provide for display the response to the prompt, and an option to initiate a session of deploying an autonomous software agent.

Additional features and advantages of one or more embodiments of the present disclosure are outlined in the description which follows, and in part will be obvious from the description, or may be learned by the practice of such example embodiments.

### BRIEF DESCRIPTION OF THE DRAWINGS

This disclosure will describe one or more embodiments of the invention with additional specificity and detail by referencing the accompanying figures. The following paragraphs briefly describe those figures, in which:

FIG. 1 illustrates an overview diagram of an intelligent repository search system executing a search of a code repository to generate a response to a prompt in accordance with one or more implementations;

FIG. 2 illustrates an example diagram of the intelligent repository search system utilizing an autonomous software agent system to access one or more code repositories and generate an index of the one or more code repositories in accordance with one or more implementations;

FIG. 3 illustrates an example diagram of the intelligent repository search system utilizing a plurality of machine learning models in tandem with a plurality of search engines to generate a response to a prompt in accordance with one or more implementations;

FIG. 4 illustrates an example diagram of the intelligent repository search system utilizing various artificial intelligence models of the autonomous software agent system to generate an index of a code repository, execute a search of a code repository, and/or to deploy an autonomous software agent in accordance with one or more implementations;

FIG. 5 illustrates an example diagram of the intelligent repository search system receiving a deep research prompt, initiating an autonomous software agent, and/or receiving a follow-up prompt in accordance with one or more implementations;

FIG. 6 illustrates the intelligent repository search system utilizing the autonomous software agent system to deploy an autonomous software agent to generate computer code in accordance with one or more implementations;

FIGS. 7A-7B illustrates example diagrams of architectural components of an autonomous software agent deployed by the intelligent repository search system using the autonomous software agent system in accordance with one or more implementations;

FIGS. 8A-8G illustrates example graphical user interfaces of the intelligent repository search system providing search functionality and deploying an autonomous software agent in accordance with one or more implementations;

FIG. 9 illustrates an example environment in which the intelligent repository search system operates in accordance with one or more implementations;

FIG. 10 illustrates an example series of acts for generating a response to a prompt submitted via an intelligent search interface in accordance with one or more implementations; and

FIG. 11 illustrates a block diagram of an exemplary computing device in accordance with one or more implementations.

### DETAILED DESCRIPTION

One or more embodiments described herein includes an intelligent repository search system that integrates with an autonomous software agent system to allow user input to search a code repository. To illustrate, in one or more embodiments, the intelligent repository search system provides an intelligent search interface to a user of a computing device to ask questions (e.g., via one or more user inputs) about one or more code repositories that are available to the autonomous software agent system. In particular, in response to a prompt submitted via the intelligent search interface, the intelligent repository search system can return a response to the prompt along with source information (e.g., code snippets and file paths). In other words, the intelligent repository search system can provide the source information to the user of the computing device that submitted the prompt in a manner that allows a user to access the information underpinning the response.

In one or more embodiments, the intelligent repository search system allows a user of a computing device to use the intelligent search interface to identify specific features (e.g., code snippets and/or potential bugs) within a code repository. Further, in some embodiments, for software features already implemented into a code repository, the intelligent repository search system also allows a user of a computing device to identify specific commits within the code repository and even investigate potential computer code bugs in the code repository.

In some embodiments, beyond searching for computer code/specific features within a code repository, the intelligent repository search system allows a user to submit one or more prompts (e.g., in a conversational manner via the intelligent search interface which is a conversational interface) to pull together relevant context for a specific software coding task. Moreover, after the user of the computing device pulls together relevant context for the specific software coding task, the intelligent repository search system allows the user of the computing device to kick-off/initiate an autonomous software agent session (e.g., a Devin session that deploys an autonomous artificial intelligence engineer). Accordingly, the intelligent repository search system leverages artificial intelligence models to reason about the quality of computer code in a connected code repository and flags potential dependencies that would be impacted if changes were made to the code repository.

To illustrate, the intelligent repository search system can receive one or more prompts from a user of a computing device (e.g., a support engineer) to search the code repository and diagnose the root cause for a user reported computer code bug. In particular, the user of the computing device can submit a support ticket (e.g., issue) via the intelligent search interface and the intelligent repository search system both identifies (e.g., pulls together) the relevant code snippets and identifies a response diagnosing the potential issue (e.g., a hypothesis/hypotheses for the bug causes). Furthermore, the user of the computing device (e.g., the support engineer) can then attach the identified/generated context as context for the autonomous software agent system to fix via a software coding task.

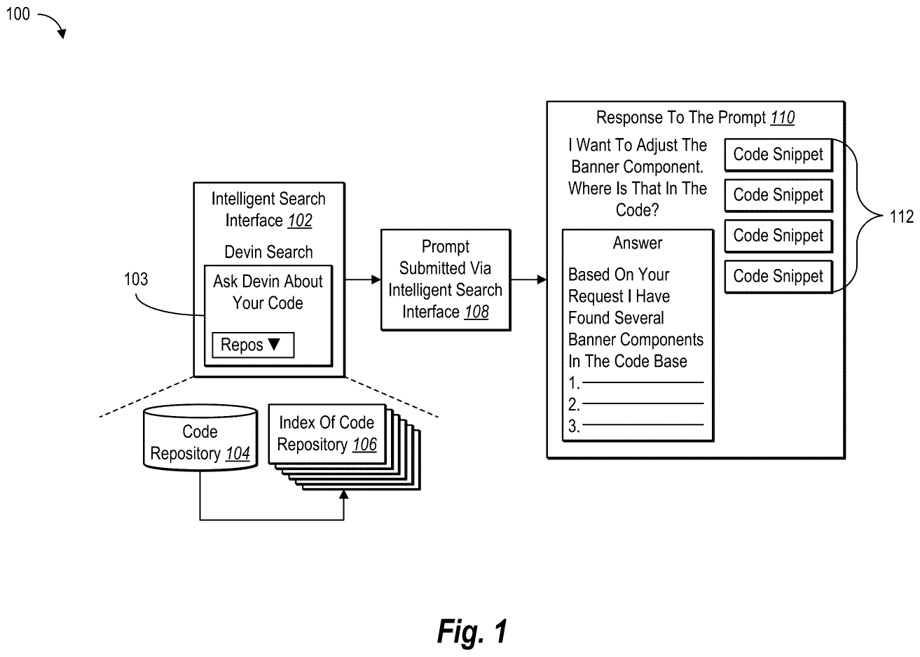

As shown in FIG. 1, an intelligent repository search system 100 generates an intelligent response to a prompt regarding a code repository in accordance with one or more embodiments. For example, FIG. 1 shows the intelligent repository search system 100 providing to a user of a computing device an intelligent search interface 102 where a user of a computing device has an option 103 to submit a prompt.

In one or more embodiments, the intelligent search interface 102 refers to an interface to submit one or more prompts about one or more code repositories that are available to an autonomous software agent system. For example, the intelligent repository search system 100 provides options for a user of a computing device to connect one or more code repositories to the autonomous software agent system. In other words, the intelligent repository search system 100 allows a user of a computing device to grant access permissions (e.g., via user input) to a code repository. In doing so, the intelligent repository search system 100 provides the intelligent search interface to the user of the computing device to further query/question the intelligent repository search system 100 regarding the one or more code repositories available to the autonomous software agent system.

As shown in FIG. 1, the intelligent repository search system 100 provides the intelligent search interface 102 which has access to a code repository 104 and an index 106 of the code repository 104. In one or more embodiments, the code repository 104 refers to a centralized location where software computer code is stored, managed, and controlled (e.g., controlled for different deployment versions such as development, web application, cloud, etc.).

In particular, the code repository 104 includes computer code, computer code documentation (e.g., files explaining how to use, setup, and contribute to one or more projects), configuration files (e.g., environment configuration, application configuration, deployment configuration, etc.), and assets (e.g., images, CSS files, JavaScript files, fonts, external libraries, audio/video files, etc.). For example, software applications/systems utilize one or more code repositories to organize computer code, collaborate on computer code projects, and maintain computer code over time.

In other words, the code repository 104 enables multiple software developers to collaborate on computer code projects (e.g., software development teams can upload and download changes to and from the code repository) by creating branches to work on specific features or computer code bugs, and once a branch is completed, merging their changes into the code repository 104 that software developers can access.

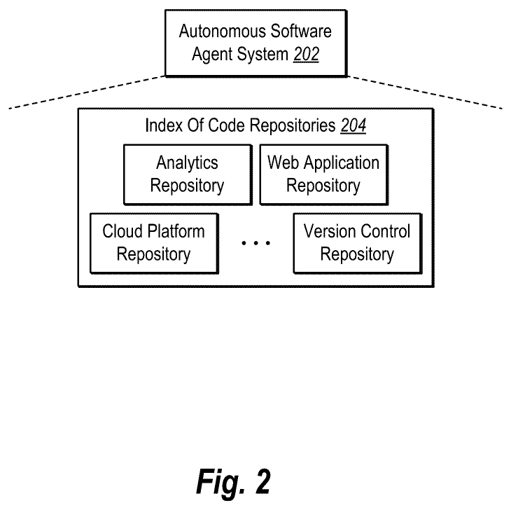

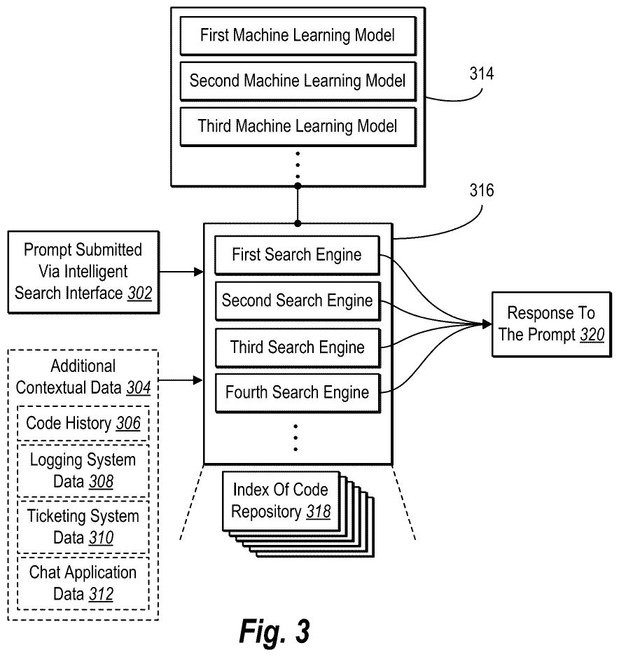

As also shown in FIG. 1 and mentioned above, the intelligent repository search system 100 generates the index 106 of the code repository 104. In particular, the intelligent repository search system 100 utilizes the index 106 (e.g., generated from the code repository 104) to generate a response to the prompt. Additional details of the intelligent repository search system 100 generating the index 106 is given below in the description of FIGS. 2 and 3.

As shown in FIG. 1, the intelligent repository search system 100 receives a prompt 108 (e.g., a prompt submitted via the intelligent search interface 102). In one or more embodiments, the prompt 108 refers to a request, question, or instruction to elicit a specific response or action from a model. Specifically, the intelligent repository search system 100 receives the prompt 108 that includes text instructions to guide a model to generate a specific response. For example, the prompt 108 includes a question regarding one or more elements within the code repository 104. In some embodiments, the intelligent repository search system 100 receives the prompt 108, which further specifies which of the code repositories (e.g., available to the autonomous software agent system) the prompt is related to, from a user via a computing device.

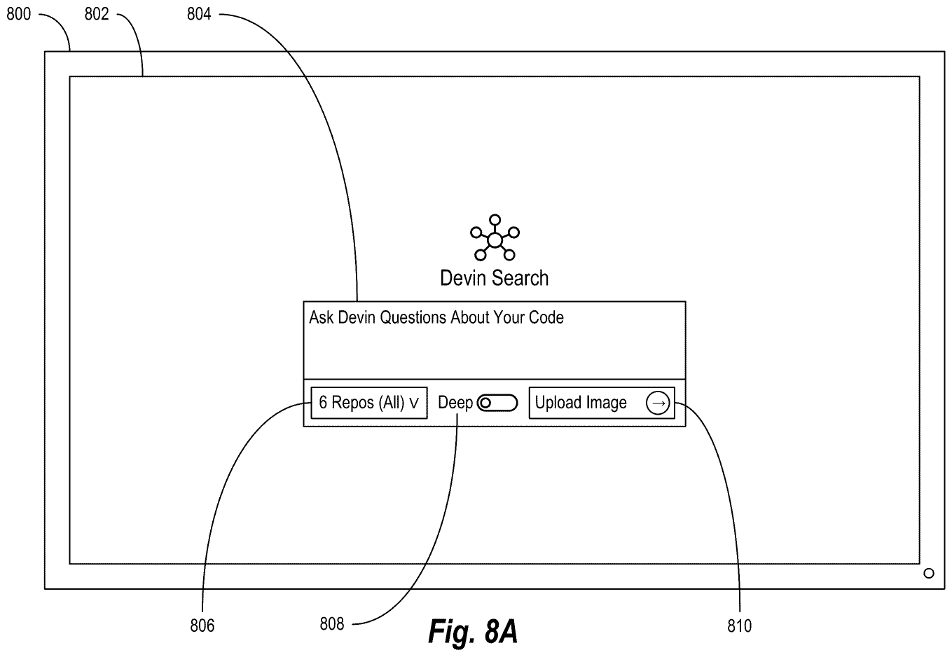

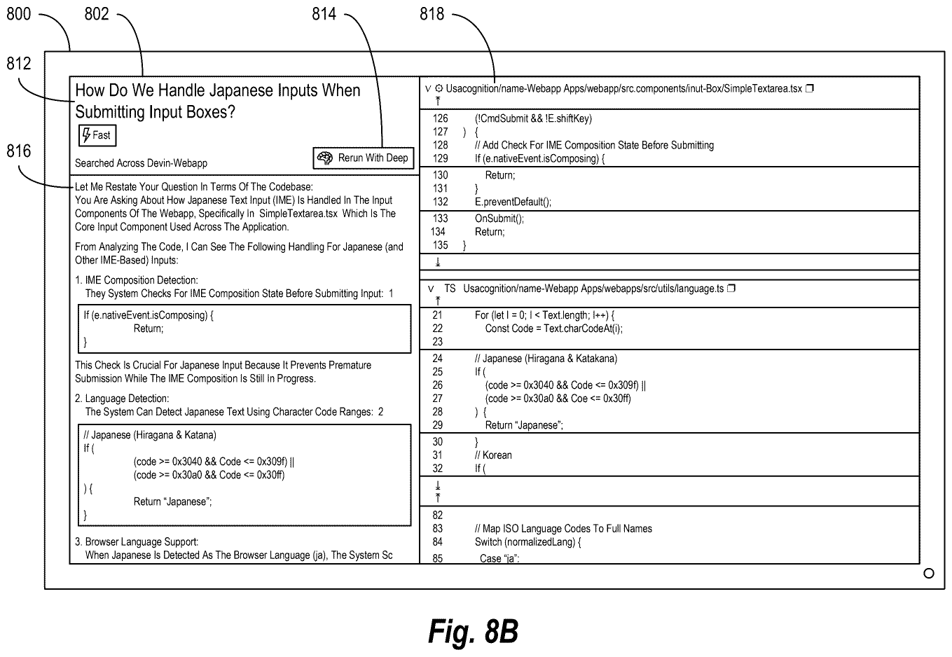

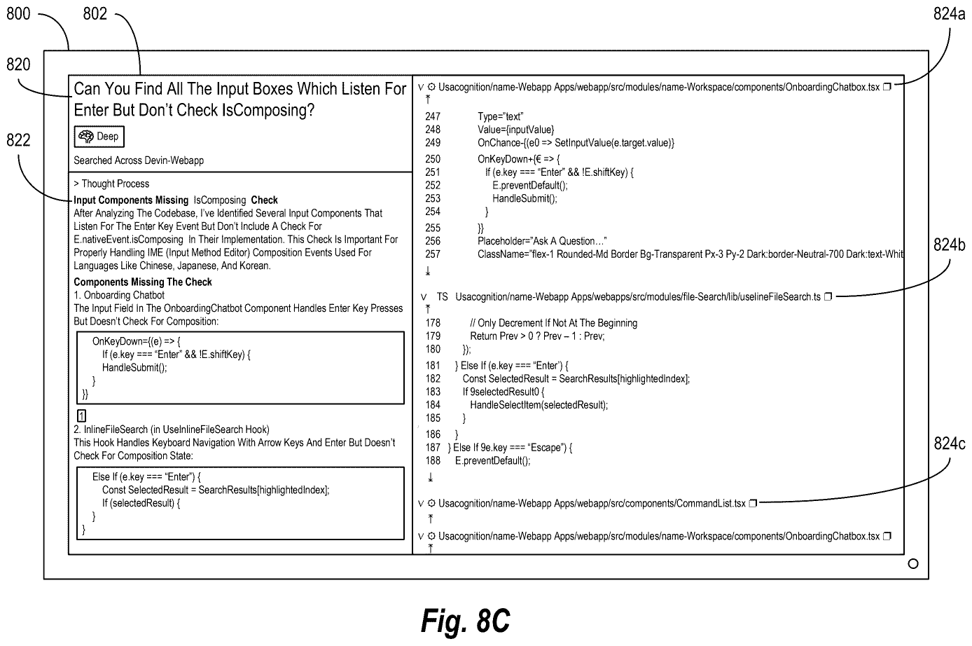

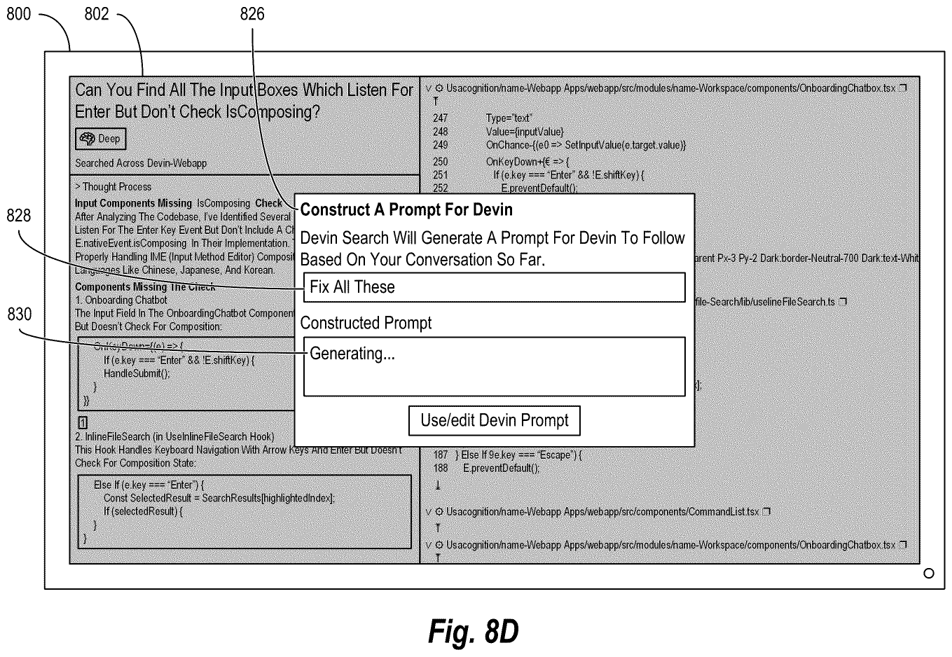

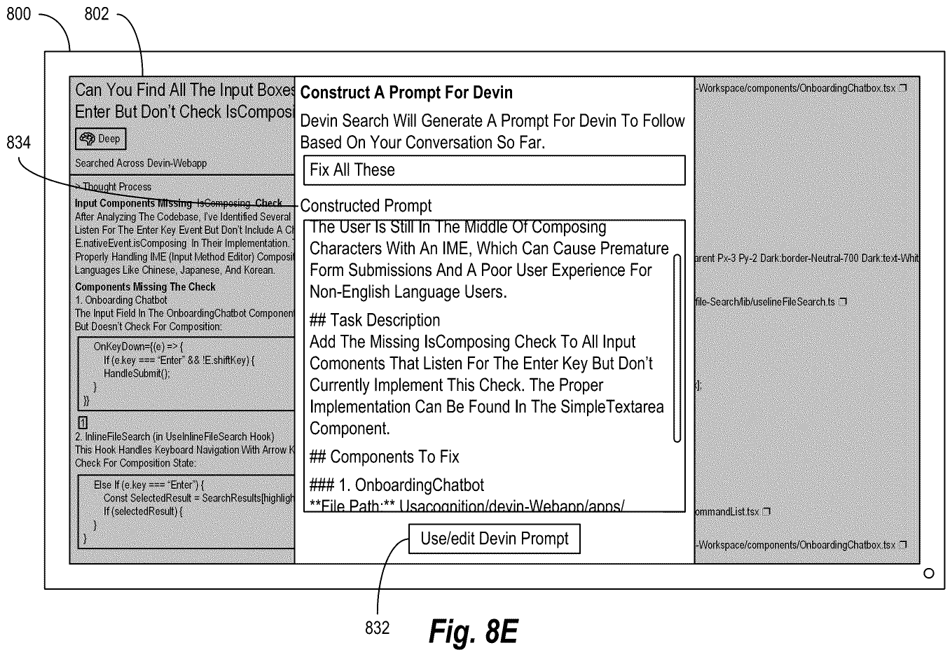

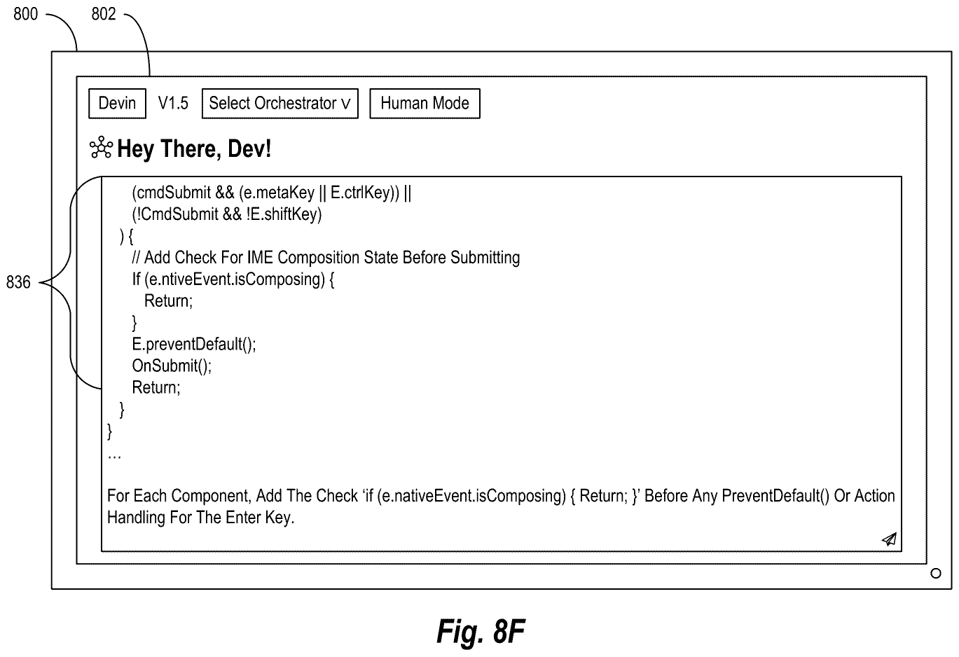

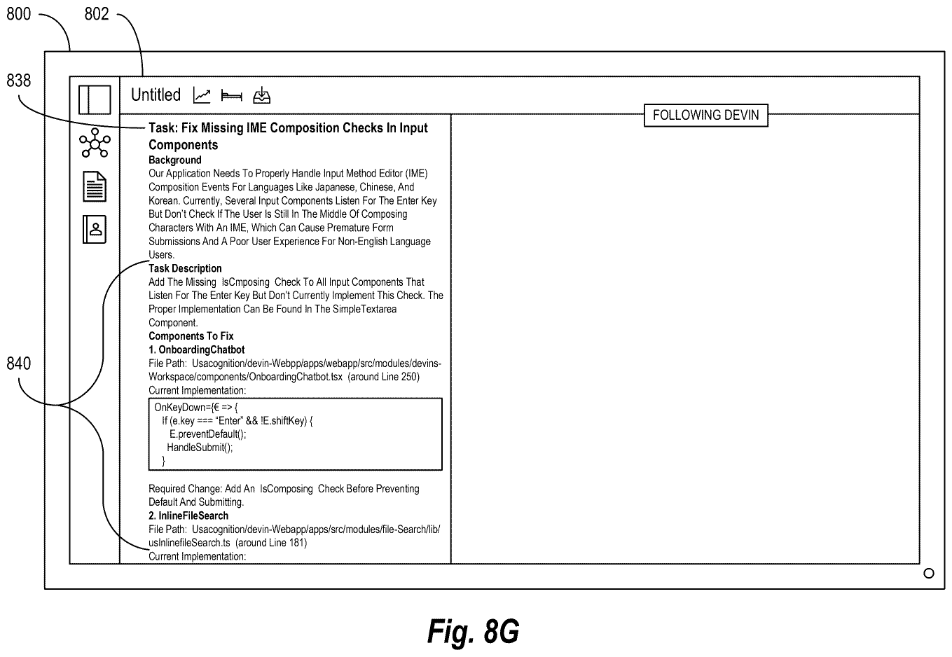

To illustrate, the intelligent repository search system 100 receives a prompt of “I want to adjust the banner component. Where is that in the code?” In other words, the intelligent repository search system 100 receives the prompt 108 relating to a request to understand features within the code repository 104 that handle banner components. Thus, the intelligent repository search system 100 leverages the prompt 108 and the index 106 to guide one or more machine learning models to determine a response to the prompt. Additional details of a specific prompt example are given below in the description of FIGS. 8A-8F.

As further shown in FIG. 1, the intelligent repository search system 100 receives the prompt 108 via the intelligent search interface 102 and further generates a response 110 to the prompt. In one or more embodiments, the response 110 to the prompt 108 refers to an output that includes content and context that is responsive and relevant to the submitted prompt. In particular, the response 110 includes information that is pertinent and in context of the code repository 104, as the prompt 108 is a question related directly to the code repository 104 that is available to the autonomous software agent system.

In some embodiments, the response 110 to the prompt 108 further includes a diagnoses of potential computer code issues in the code repository 104 connected to the autonomous software agent system. In particular, the response 110 can identify bugs in computer code of the code repository 104. Moreover, the intelligent repository search system 100 can also include as part of the response 110, potential dependencies in the code repository 104 that would need to be modified if the potential bug/issue is addressed.

Furthermore, FIG. 1 shows that the response 110 to the prompt 108 includes an answer of “based on your request I have found several banner components in the code base . . . ” In particular, the intelligent repository search system 100 identifies several relevant banner components in the code repository 104 that conform with the prompt 108. Moreover, the intelligent repository search system 100 also provides source information 112 accompanying the response 110.

In one or more embodiments, the source information 112 refers to details about where in the code repository information used to generate the response 110 is found. In other words, the source information 112 provides grounding information or credible context from the code repository 104 that is used to generate the response 110. In particular, the source information 112 refers to code snippets and file paths in the code repository that are related to the prompt submitted by the user via the intelligent search interface 102.

As shown in FIG. 1, as part of the response 110, the intelligent repository search system 100 provides code snippets. In one or more embodiments, a code snippet refers to a block of code that is part of a larger computer program or computer script. In particular, a code snippet is directed to perform a particular task, or to demonstrate a specific functionality. Furthermore, in some embodiments, the intelligent repository search system 100 can also provide file paths along with the provided code snippets. In one or more embodiments, a file path refers to a specific location of a file or directory within the code repository 104. In particular, the file path refers to the specific file and folder in the code repository 104.

As mentioned above, existing systems that provide code generation assistance are inefficient. For example, these existing systems merely supplement developer work. In particular, existing systems require heavily involved guidance, prompting, monitoring, and the use of a developer's device in order to supplement developer work. In other words, existing systems merely act as a co-pilot to a developer. Accordingly, existing systems suffer from computational inefficiencies of attempting to integrate a code development assistant into a developer's workflow and often suffer from being prompted and re-prompted to yield satisfactory results.

Thus, existing systems often generate supplementary computer code that has a high failure rate of actually being implemented into a code base. In particular, based on the just-mentioned problems, existing systems use code generation assistants to assist a developer, but often lack an intimate, thorough, and advanced understanding of a codebase (e.g., code repository) that a developer is working on (e.g., especially for very large and complex code repositories). As such, existing systems generate useless computer code to supplement a developer's work or develop computer code that needs a lot of oversight/review to put it in a condition that is sufficiently useful.

Moreover, existing systems often operate on extremely complex codebases. In particular, existing systems often use codebases with hundreds, thousands, or hundreds of thousands of files, configurations, code conventions, and documentation. As such, newly added developers to a software development team are often missing key context and nuance surrounding how a complex codebase operates.

Accordingly, newly added developers further exacerbate efficiency issues by relying too heavily on code generation assistants. In other words, newly added developers may leverage code generation assistants to generate supplementary computer code, however because of the lack of experience and knowledge of the newly added developers, they fail to catch incorrect computer code. Thus, existing systems suffer from integrating computer code that does not operate correctly, which further increases the time and resources used to fix up the faulty code in a codebase.

As alluded to above, in addition to their inefficiency issues, existing systems are also inaccurate. More particularly, due to the standard paradigm of existing systems supplementing code development, existing systems are often incomplete or inadequate in generating complex and extensive computer code. Moreover, existing systems often supplement code development efforts but generate computer code that inaccurately addresses an intent (expressed by an input prompt) and/or that is operationally invalid, including syntactic errors, semantic errors, logical errors, and/or errors that result from a lack of understanding of a complex set of code repositories.

Relatedly, existing systems further suffer from operational inflexibility. Because existing systems are limited to supplementing code development for cases expressly coded by engineers, these existing systems fail to adapt to creating new computer code, tackling complex non-trivial tasks, understanding already generated computer code and/or performing tests on computer code. Indeed, the inflexible nature of existing systems severely hampers the ability of existing systems to keep up with the taxing demands of software development from a holistic perspective, especially in the context of complex code repositories.

Moreover, some existing systems are insecure. While certain existing systems can assist developers in supplementing computer code, these systems generally require developers to provide sensitive information. By providing sensitive information to these existing systems, developers unwillingly expose their software applications to malicious attacks or risk leaking the information to unwanted third-party applications.

In one or more embodiments, the intelligent repository search system 100 provides several improvements over conventional systems in relation to efficiency, accuracy, operational flexibility, and security. In contrast to existing systems, which require heavily involved guidance, prompting, monitoring, and the use of a developer's device in order to supplement developer work, the intelligent repository search system 100 deploys an autonomous software agent that operates as an independent virtual machine in a shared development environment.

In doing so, the intelligent repository search system 100 uses the autonomous software agent system which allows for an autonomous software agent to operate independently to solve non-trivial tasks, and it does not conflate or confuse context of other ongoing tasks. Specifically, the intelligent repository search system 100 uses the autonomous software agent system to silo/isolate autonomous software agents such that the autonomous software agents can accurately and efficiently perform their assigned tasks without being bogged down by additional information.

Furthermore, in contrast to existing systems which lack an intimate, thorough, and advanced understanding of a code base that a developer is working on, the intelligent repository search system 100 generates an index of a code repository (e.g., available to the autonomous software agent system) and provides an intelligent search interface for a user of a computing device to search the code repository.

For example, by generating the index of the code repository, the intelligent repository search system 100 enables an autonomous software agent to have a thorough, nuanced, and intimate understanding of the code base (e.g., the index captures an abstraction summary of the code repository). In doing so, the intelligent repository search system 100 allows a user to pull together relevant context (e.g., from their prompt and the generated response), and then deploys an autonomous software agent to execute software coding tasks based on the pulled together context.

As mentioned above, existing systems operate on extremely complex codebases and struggle with incorporating newly added developers. In particular, existing systems often suffer from inefficiencies due to newly added developers using code generation assistants to supplement a codebase with faulty code. In contrast, the intelligent repository search system 100 provides the intelligent search interface for a user of a computing device to submit prompts of questions regarding a code repository. In other words, the intelligent repository search system 100 provides tools for newly added developers to effectively and accurately gain an understanding of a code repository.

Moreover, rather than inaccurately relying on a code generation assistant, the intelligent repository search system 100 further allows a user to submit prompts to gather the relevant context and computer code in the code repository and then deploy an autonomous software agent to execute a software task based on the relevant context and computer code. In particular, based on the intelligent repository search system 100 generating an index of a code repository and allowing users to search the index of the code repository, the intelligent repository search system 100 also enables a user of a computing device to more effectively utilize artificial intelligence to generate computer code.

Accordingly, the intelligent repository search system 100 reduces inefficiencies by using an effective and accurate autonomous software agent system that has a thorough and intimate understanding of a code repository. In other words, the intelligent repository search system 100 compensates for the inexperience of newly added developers by generating an index of a code repository and allowing newly added developers to submit prompts regarding the code repository. Thus, the intelligent repository search system 100 reduces the time and resources used to fix up faulty code caused by newly added software developers (e.g., using artificial intelligence to generate computer code).

In one or more embodiments, the intelligent repository search system 100 further improves upon inaccuracies. In contrast to existing systems, which are often incomplete or inadequate in generating complex and extensive computer code for complex code repositories, the intelligent repository search system 100 uses the autonomous software agent system which uses an intelligent orchestration process to determine how to understand a code repository/environment to generate an index of the code repository.

As a result, the intelligent repository search system 100 can more effectively generate responses to prompts regarding a code repository (e.g., using the generated index) and can further deploy an autonomous software agent that determines how to generate computer code that matches a determined context, and how to choose between various artificial intelligence models to accomplish various tasks. Accordingly, the intelligent repository search system 100 more accurately generates complex and extensive computer code, especially in the context of newly added developers leveraging computer code generation models.

In one or more embodiments, the intelligent repository search system 100 further improves upon operational inflexibilities. In contrast to existing systems, which are rigidly tied to code supplementation, the intelligent repository search system 100 allows a user to pull together relevant context for a software task (e.g., via submitting prompts through to the intelligent search interface).

Moreover, the intelligent repository search system 100 uses the autonomous software agent system to deploy an autonomous software agent that operates as an independent virtual machine computing device and further allows a user to monitor/modify the progress of the autonomous software agent (if so desired). Thus, the intelligent repository search system 100 provides advanced and intelligent search features for code repositories available to the autonomous software agent system and also provides advanced computer code generation features based on searches of a code repository.

Furthermore, because the intelligent repository search system 100 uses the autonomous software agent system to deploy an autonomous software agent that is provided with various development box tools (e.g., browser, planner, editor, and shell), the intelligent repository search system 100 acts as an advanced reasoning tool to complete non-trivial tasks. Accordingly, the intelligent repository search system 100 enhances the flexibility of operations in understanding a code repository and performing code generation tasks.

Additionally, in some embodiments, the intelligent repository search system 100 enhances security relative to existing systems. For example, the intelligent repository search system 100 provides an option to provide access credentials of a code repository to the autonomous software agent system. In particular, the intelligent repository search system 100 performs code repository understanding tasks and computer code generation tasks when the autonomous software agent system has access to a code repository.

In this manner, the intelligent repository search system 100 insulates software applications from malicious attacks and reduces the risk of leaking information to unwanted third-party applications. In other words, the intelligent repository search system 100 provides selective options for software developers to determine the types of access permissions and which specific code repositories to provide to the autonomous software agent system which is integrated with the intelligent repository search system 100.

As mentioned above, the intelligent repository search system 100 utilizes an autonomous software agent system to execute searches of a code repository, deploy an autonomous software agent, and perform a variety of code repository indexing tasks/software coding tasks. FIG. 2 shows the intelligent repository search system 100 utilizing an autonomous software agent system to access one or more code repositories and to generate one or more indexes of the one or more code repositories in accordance with one or more embodiments. For the sake of brevity, the following describes the autonomous software agent system performing one or more actions, however technically, it is the intelligent repository search system 100 utilizing the autonomous software agent system to perform one or more actions.

In some embodiments, the intelligent repository search system 100 utilizes an autonomous software agent system 202 to seamlessly synchronize with code repositories (e.g., code repository organization managers, such as Git Managers). In particular, when users of computing devices sign up for an account with the autonomous software agent system 202, the users of the computing devices can connect with their code repository organization (Github organization), which involves installing a code repository application (e.g., Github application) into their workspace. Moreover, the autonomous software agent system 202 provides an option to specify a personal access token if the user does not have the permissions to install the code repository application into their organization.

Moreover, as mentioned, the autonomous software agent system 202 provides integration with a code repository, which allows the autonomous software agent system 202 to do various actions, such as creating PULL requests, commenting on repository group pull requests, and reviewing repository group actions (e.g., their code did not pass the check you cannot merge this code).

In addition, the intelligent repository search system 100 utilizes the autonomous software agent system 202 to obtain a thorough understanding of a code repository. As shown in FIG. 2, the intelligent repository search system 100 utilizes the autonomous software agent system 202 to access an analytics repository, a web application repository, a cloud platform repository, and a version control repository. As mentioned above, the autonomous software agent system 202 accesses the shown code repositories based on a user of a computing device granting access permissions to the code repositories.

Moreover, FIG. 2 shows the autonomous software agent system 202 generating an index 204 (e.g., indices) of the accessed code repositories. In one or more embodiments, the intelligent repository search system 100 uses one or more machine learning models of the autonomous software agent system 202 (e.g., Devin's Brain) to generate an index of a code repository. In particular, an index of a code repository refers to a process of creating an abstraction summary of a code repository.

In other words, the intelligent repository search system 100 generates the index 204 using the autonomous software agent system 202 to subdivide/break down a code repository into core parts and determines the structure and hierarchy of the code repository. For example, the intelligent repository search system 100 utilizes one or more machine learning models of the autonomous software agent system 202 to analyze the code repository and determine the purpose of different parts of the code repository, how files are organized in the code repository, and different methods and technologies in the code repository.

In one or more embodiments, the autonomous software agent system 202 generates the index 204 using the machine learning models by identifying/determining a purpose of the code repository, the key features of the code repository, the computer languages in the code repository, the technology stack, different files, and external libraries. In particular, from identifying/determining these aspects, the autonomous software agent system 202 extracts system architecture diagrams from the code repository, computer code documentation, and computer code conventions.

In one or more embodiments, a system architecture diagram refers to a visual representation that outlines the structure and components of a software system and how those components interact with each other. In other words, a system architecture diagram outlines how a system is organized and relationships between different components (e.g., modules such as applications, databases, application programming interfaces, third-party integrations, etc.) in the software system. For example, system architecture diagrams can include logical architecture (e.g., the flow of data), physical architecture (e.g., hardware devices and servers), and cloud architecture. Accordingly, the intelligent repository search system 100 processes (e.g., using machine learning models of the autonomous software agent system 202) the code repositories to generate the system architecture diagrams of the code repositories.

In one or more embodiments, computer code documentation refers to written and/or visual descriptions of the functionality and structure of the code repository. In particular, computer code documentation refers to an explanation of how different computer code in the code repository operates, how to use the computer code, and how to maintain and add to the code repository. For example, computer code documentation can include short or long comments that are related to specific code snippets and explain specific lines or sections of computer code.

In some embodiments, the computer code documentation includes README files (e.g., introduces a project and how to setup the project), change logs, and API documentation. Accordingly, the intelligent repository search system 100 processes the code repositories (e.g., using machine learning models of the autonomous software agent system 202) to generate the computer code documentation. In particular, the intelligent repository search system 100 can extract various comments and compile them together to create one or more computer code documents.

In one or more embodiments, computer code conventions refer to guidelines and practices for software developers to follow when adding/editing computer code in the code repository. In particular, computer code conventions outline guidelines/principles to keep computer code consistent, readable, and maintainable. For example, computer code conventions include formatting guidelines, naming, structure, and documentation. Accordingly, the intelligent repository search system 100 processes the code repository (e.g., using machine learning models of the autonomous software agent system 202) to generate the computer code conventions (e.g., by extracting/inferring the conventions or by compiling documents that expressly discuss the compute code conventions).

In one or more embodiments, the intelligent repository search system 100 utilizes the one or more machine learning models of the autonomous software agent system 202 to generate a visualization (e.g., a wiki) of the generated index of the code repository. In other words, the intelligent repository search system 100 generates a visualization of the process in which the autonomous software agent system 202 uses to parse through the code repository. For example, the created visualization (e.g., wiki) of the code repository can be provided to a user of a computing device to better understand the system architecture, the code conventions, and the key features/functionalities of the code repository. Furthermore, in some embodiments, the intelligent repository search system 100 further draws upon additional contextual data to generate the index 204 of the code repository.

As mentioned above, the intelligent repository search system 100 provides intelligent search features of a code repository that is available to the autonomous software agent system in order to generate a response to a prompt about the code repository. FIG. 3 illustrates the intelligent repository search system 100 using a plurality of machine learning models (e.g., of the autonomous software agent system) and a plurality of search engines (e.g., in tandem and in parallel) to generate a response to a prompt in accordance with one or more embodiments.

As shown in FIG. 3, the intelligent repository search system 100 receives a prompt 302 submitted via an intelligent search interface. Further, FIG. 3 shows that in some embodiments, the intelligent repository search system 100 further draws upon additional contextual data 304. In one or more embodiments, the intelligent repository search system 100 uses the prompt 302 and the additional contextual data 304 to generate a response to the prompt 302. In particular, additional contextual data refers to data in addition to the immediate code repository (e.g., additional metadata, files, external systems, etc.).

As shown in FIG. 3, in some embodiments, the additional contextual data 304 includes code history 306, logging system data 308, ticketing system data 310, and chat application data 312. In one or more embodiments, the code history 306 refers to a record of changes made to the code repository. For example, the code history 306 includes modifications, additions, deletions, and updates to the computer code. Further, the code history 306 can include timestamps, author information, and comments describing various changes to computer code.

In some embodiments, the code history 306 is external to the code repository and refers to snapshots/states of the code repository over time. In particular, the code history 306 can be stored in an external database (e.g., external to the code repository). Accordingly, the intelligent repository search system 100 can leverage code history to generate a response to the prompt.

In one or more embodiments, logging system data 308 refers to a record of information regarding operations, events, and activities in a software system. For example, logging system data 308 can include a log of data from client devices interacting with a software system. In particular, a logging system can exist external to the code repository and monitors various interactions with a software system. Moreover, the logging system can collect, store, and analyze the data for diagnosing, tracking, and monitoring the state of a software application. Accordingly, the intelligent repository search system 100 can leverage the logging system data 308 to generate a response to the prompt.

In one or more embodiments, a ticketing system refers to a software tool to track tasks, bugs, and features. For example, a ticketing system allows software development teams to manage and prioritize their workload, assign tasks, and track the progress of tasks. In particular, a ticketing system typically provides options for users to submit issue tickets that include various fields describing a task, a workflow to assign the ticket to a silo of developers, comments on the ticket, attachments for the ticket, and linked issues. Accordingly, the intelligent repository search system 100 leverages the ticketing system data 310 extracted from a ticketing system to generate a response to the prompt.

In one or more embodiments, a chat application refers to a software tool for digital communication and collaboration between different users, teams, and organizations. In particular, a chat application provides text-based messaging for group chats and direct messages between users to enhance interactions, especially in the context of software development. In some embodiments, the intelligent repository search system 100 extracts the chat application data 312 to generate the response to the prompt.

As shown in FIG. 3, the intelligent repository search system 100 uses a plurality of machine learning models 314 (e.g., first machine learning model, a second machine learning model, a third machine learning model, etc.) and a plurality of search engines 316 (e.g., a first search engine, a second search engine, a third search engine, a fourth search engine, etc.) to generate a response 320. Further, FIG. 3 shows that plurality of search engines 316 integrated with the plurality of machine learning models 314. In particular, the intelligent repository search system 100 utilizes the plurality of machine learning models 314 (e.g., of the autonomous software agent system) and the plurality of search engines 316 to effectively and accurately generate results that are responsive to the prompt 302.

In some embodiments, the intelligent repository search system 100 uses the autonomous software agent system that includes one or more machine learning models, neural networks, and/or large language models. Thus, the intelligent repository search system 100 uses the autonomous software agent system which leverages various machine learning components used to analyze, process, and generate information.

In one or more embodiments a machine learning model includes a computer algorithm or a collection of computer algorithms that can be trained and/or tuned based on inputs to approximate unknown functions. For example, a machine learning model can include a computer algorithm with branches, weights, or parameters that changed based on training data to improve for a particular task. Thus, a machine learning model can utilize one or more learning techniques to improve in accuracy and/or effectiveness. Example machine learning models include various types of decision trees, support vector machines, Bayesian networks, random forest models, or neural networks (e.g., deep neural networks).

Similarly, a neural network includes a machine learning model of interconnected artificial neurons (e.g., organized in layers) that communicate and learn to approximate complex functions and generate outputs based on a plurality of inputs provided to the model. In some instances, a neural network includes an algorithm (or set of algorithms) that implements deep learning techniques that utilize a set of algorithms to model high-level abstractions in data. To illustrate, in some embodiments, a neural network includes a convolutional neural network, a recurrent neural network (e.g., a long short-term memory neural network), a transformer neural network, a generative adversarial neural network, a graph neural network, a diffusion neural network, a multi-layer perceptron, a large language model (LLM), a generative pre-trained transformer model (GPT), a chain-of-thought machine learning model, etc. In some embodiments, a neural network includes a combination of neural networks or neural network components.

In one or more embodiments, the one or more machine learning models include a language model that includes a set of statistical or probabilistic functions to perform Natural Language Processing (NLP) in order to understand, learn, and/or generate human natural language content. For example, the intelligent repository search system 100 uses the autonomous software agent system which uses a language model as a tool that determines the probability of a given sequence of words occurring in a sentence or natural language sequence.

Simply put, the intelligent repository search system 100 uses the autonomous software agent system which uses a model that is trained to predict the next word in a sentence. A language model is called a large language model (LLM) when it is trained on an enormous amount of data (e.g., a threshold amount of data) and/or has a large number of parameters. These models have capabilities ranging from writing a simple essay to generating complex computer codes-all with limited to no supervision. Accordingly, an LLM can comprise a deep neural network that is very large (billions to hundreds of billions of parameters) and understands, processes, and produces human natural language by being trained on massive amounts of text.

These models predict future words in a sentence letting them generate sentences similar to how humans talk and write or otherwise in a form dictated, for instance, by a prompt. In one or more implementations, an LLM utilized by the autonomous software agent system employs a “chain-of-thought” reasoning approach that allows the model to internally deliberate before providing responses. Indeed, one or more implementations include a LLM trained using reinforcement learning techniques that enable the LLM to refine its reasoning skills through iterative feedback.

In one or more embodiments, a search engine refers to a software system designed to search for information in the code repository and to return relevant results based on the prompt. For example, the intelligent repository search system 100 leverages the pipeline of the autonomous software agent system (e.g., the multiple machine learning models) and the plurality of search engines 316 to identify one or more results from an index 318 of the code repository. In particular, the intelligent repository search system 100 uses the plurality of search engines 316 to crawl through the index 318 of the code repository and further matches the prompt (e.g., and the additional contextual data 304) to find relevant portions of the index 318 of the code repository. Moreover, the intelligent repository search system 100 uses the search engines to rank each of the results in order of importance/relevance relative to the prompt.

In one or more embodiments, the intelligent repository search system 100 uses a multi-modal large language model (e.g., one or more) as the plurality of machine learning models 314 to generate a response 320. For example, the intelligent repository search system 100 uses the multi-modal large language model to generate a plurality of prompt embeddings and a plurality of index embeddings. In particular, the intelligent repository search system 100 generates embeddings (e.g., vector representations) of both the index 318 and the prompt 302 to compare the embeddings within a unified latent space (e.g., multi-dimensional latent space) and identify results from the code repository that are responsive to the prompt 302.

In one or more embodiments, the intelligent repository search system 100 uses the multi-modal large language model to generate prompt embeddings from the prompt 302. In particular, the intelligent repository search system 100 utilizes a text encoder to generate a representation of the text prompt (e.g., such as a text token) for a machine learning task. In some embodiments, a single text token refers to a word, a sub-word, or a character (e.g., “the,” “on,” “cat,” “t,” “showcasing,” “show,” “casing,” etc.). Furthermore, the intelligent repository search system 100 uses the multi-modal large language model to generate tokens representing special meaning or purposes such as the beginning or an end of a sentence.

Further, in some embodiments, the intelligent repository search system 100 also uses a text encoder to generate representations of the index 318 of the code repository. Moreover, in some embodiments, the intelligent repository search system 100 further processes image data from documents in the code repository. In particular, the intelligent repository search system 100 utilizes an image encoder to encode image data and generate image embeddings of visual elements in the index 318 of the code repository.

In one or more embodiments, an image encoder is a neural network (or one or more layers of a neural network) that extracts features relating to digital images. In some cases, an image encoder refers to a neural network that both extracts and encodes features from a digital image. For example, an image encoder can include a particular number of layers including one or more fully connected and/or partially connected layers of neurons that extracts image patches from the digital image and encode localized features of the digital image. To illustrate, in one or more embodiments, the intelligent repository search system 100 generates an image embedding (e.g., extracts raw data) that represents a complete frame of a digital image.

In one or more embodiments, the intelligent repository search system 100 utilizes the image encoder to generate image embeddings. In some embodiments, the image embeddings include a numerical representation (e.g., a vector) of a digital image. For instance, the image embeddings capture features and properties of the digital image. To illustrate, the image embeddings include semantic information such as the presence of objects, shapes, and spatial relationships. Additionally, in some embodiments, the intelligent repository search system 100 further utilizes the text encoder and/or the image encoder to generate embeddings for the additional contextual data 304.

Moreover, the intelligent repository search system 100 projects the image embeddings into a unified latent space with text embeddings and leverages, a multi-modal artificial intelligence model (e.g., a multi-modal LLM) to generate predictions regarding the processed information. In other words, the intelligent repository search system 100 uses the multi-modal large language model (e.g., of the autonomous software agent system) to work with various data domains and can perform a wide variety of reasoning tasks to determine how to generate the response 320 to the prompt 302.

In one or more embodiments, the intelligent repository search system 100 uses a first search engine from the plurality of search engines 316 to generate a first result. For example, the intelligent repository search system 100 uses the first search engine to process a subset of prompt embeddings and a subset of index embeddings (e.g., and/or embeddings of the additional contextual data 304). In particular, the intelligent repository search system 100 selects the first search engine from the plurality of search engines 316 as the first search engine is more efficient for the subset of prompt embeddings and the subset of index embeddings. In other words, the intelligent repository search system 100 selects between search engines based on the type of processing task (e.g., the first search engine is more efficient at processing embeddings to identify code snippets).

Furthermore, the intelligent repository search system 100 uses a second search engine from the plurality of search engines 316 to generate a second result. For example, the intelligent repository search system 100 uses the second search engine to process an additional subset of prompt embeddings and an additional subset of index embeddings. In particular, the intelligent repository search system 100 selects the second search engine from the plurality of search engines 316 as the second search engine is more efficient for processing the additional subset of prompt embeddings and the additional subset of index embeddings (e.g., the second search engine is more efficient at processing embeddings to identify file paths). In some embodiments, the intelligent repository search system 100 further selects a third search engine to process the additional contextual data 304 and generates a third result.

Moreover, in some embodiments, the intelligent repository search system 100 switches between different search engines of the plurality of search engines 316 based on processing time, accuracy, search engine size, computational efficiency, scalability, data modality, interpretability, robustness, cost, and flexibility (e.g., the intelligent repository search system 100 can rely on one or more of the aforementioned factors to determine which search engine to select). In other words, the intelligent repository search system 100 generates the plurality of index embeddings and the plurality of prompt embeddings and then divides up some search engines to process some embeddings and other search engines to process other embeddings.

In one or more embodiments, the intelligent repository search system 100 uses the plurality of search engines 316 and the plurality of machine learning models 314 in tandem. In particular, the intelligent repository search system 100 uses the plurality of machine learning models 314 to work together with the plurality of search engines 316 to generate the results. Moreover, the intelligent repository search system 100 can use a subset of the plurality of machine learning models 314 to process some data while a subset of the plurality of search engines 316 is processing additional data (e.g., the intelligent repository search system 100 uses the plurality of machine learning models 314 and the plurality of search engines 316 to process data in parallel).

Additionally, the intelligent repository search system 100 can also switch between different multi-modal large language models attuned for different tasks. In particular, the intelligent repository search system 100 can leverage a first multi-modal large language model to process a subset of data from the index 318 and a second multi-modal large language model to process an additional subset of data from the index 318. Moreover, in some embodiments, the intelligent repository search system 100 can use a third multi-modal large language model to process the additional contextual data 304. For example, the intelligent repository search system 100 can determine to switch between different multi-modal large language models based on processing time, accuracy, model size, computational efficiency, scalability, data modality, interpretability, robustness, cost, and flexibility.

Furthermore, as mentioned above, the intelligent repository search system 100 generates a first result and a second result and then combines the first and second result (e.g., and the third result) to generate the response 320 to the prompt. In some embodiments, the intelligent repository search system 100 generates a plurality of results and combines the plurality of results to arrive at the response 320.

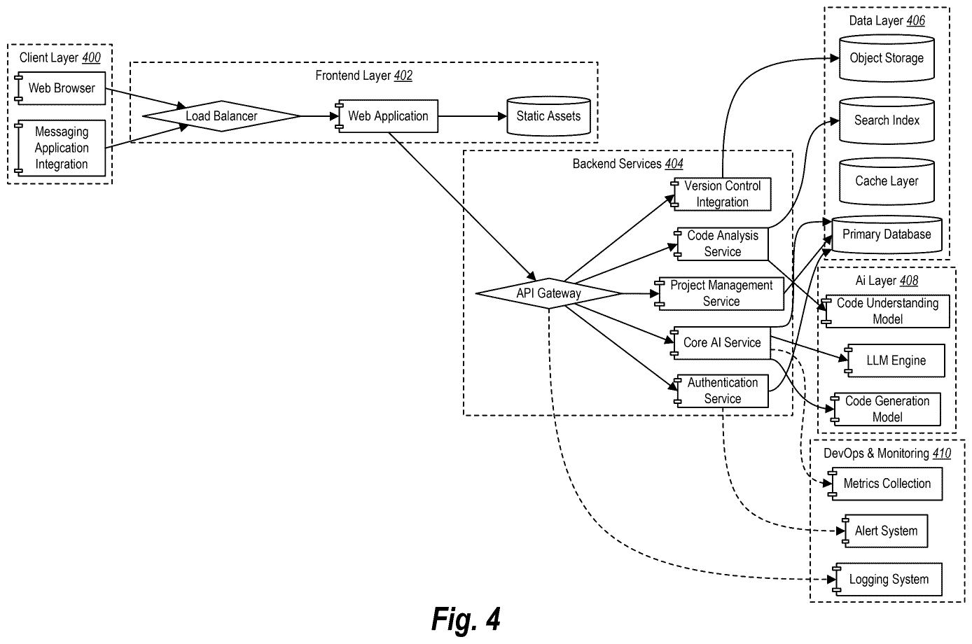

FIG. 4 illustrates architectural details of the intelligent repository search system 100 using the autonomous software agent system in accordance with one or more embodiments. In particular, the intelligent repository search system 100 works with the autonomous software agent system to generate an index of a code repository, provide responses to the prompts submitted via an intelligent search interface, and further deploys an autonomous software agent to perform software coding tasks (e.g., based on context pulled together from a submitted prompt).

As shown in FIG. 4, the intelligent repository search system 100 uses the autonomous software agent system which contains a client layer 400 (e.g., with a web browser, and a messaging application integration), a frontend layer 402 (e.g., with a load balancer (e.g., a system to distribute incoming traffic across multiple servers which optimizes efficiency), a web application (e.g., Devin web application), and static assets (e.g., files that do not dynamically change based on user interactions, such as HTML files, CSS files, JavaScript files, images, etc.)).

Moreover, FIG. 4 shows the intelligent repository search system 100 uses the autonomous software agent system which also contains backend services 404 (e.g., with an API gateway (e.g., a single entry point for managing and routing API requests from client devices to different microservices/backend systems), a version control integration (e.g., a backend service application to track changes to code such as the connected code repository application like Github), a code analysis service, a project management service (e.g., a software system to track the development of various tasks that a software development team is working on), a core AI service (e.g., artificial intelligence modules or tools to handle the use of machine learning models, natural language processing, and other artificial intelligence tasks), and an authentication service).

In particular, the backend services 404 include applications that all communicate with the backend web-server of the autonomous software agent system, which performs the job of generating an index of a code repository, searching an index of a code repository and orchestrating/managing sessions (Devin sessions), as well as providing the APIs to display data about the autonomous software agent system on computing devices.

Further, FIG. 4 shows a data layer 406 (e.g., with object storage (e.g., storage of unstructured data), search index (e.g., an index of the code repository discussed above), a cache layer (e.g., a layer that temporarily holds frequently accessed or recently computed data), a primary database (e.g., a central data store to hold application data)), an AI layer 408 (e.g., with a code understanding model, an LLM engine, and a code generation model), and a DevOps and Monitoring layer 410 (e.g., with metrics collection, an alert system, and a logging system).

As shown in FIG. 4, the autonomous software agent system utilizes the AI layer 408 to perform a variety of reasoning/generation tasks. In particular, the autonomous software agent system accesses the AI layer 408 every time a code repository is connected or updated, or a new session is spun up (e.g., each time a new development box is activated). In order to enable the AI layer 408 of the autonomous software agent system, the intelligent repository search system 100 provides various onboarding tools to a user of a computing device. In particular the onboarding tools allows a user to provide access to a code repository provider (e.g., a Gitprovider), select repositories, assign read access, and assign write access.

In some embodiments, the intelligent repository search system 100 prompts a user of a computing device for additional access permissions. In particular, the intelligent repository search system 100 can prompt the user for additional access permissions after generating a response to a prompt or during an autonomous software agent session. For example, the intelligent repository search system 100 determines during generating a response or executing software coding tasks that additional knowledge/permissions are needed to more thoroughly respond/perform a task.

FIG. 4 illustrates the intelligent repository search system 100 using the architecture of the autonomous software agent system to generate an index of a code repository. In particular, at the client layer 400, the intelligent repository search system 100 receives a connection between a code repository and the autonomous software agent system. In response, to the input via the client layer 400, the intelligent repository search system 100 further leverages the backend services 404 to analyze the code of the code repository. Moreover, the intelligent repository search system 100 utilizes the AI layer 408 to generate an index of the connected code repository (e.g., and subsequently a wiki of the index).

As further shown in FIG. 4, the AI layer 408 of the autonomous software agent system further includes a code understanding model. In particular, the code understanding model analyzes computer code. In other words, the intelligent repository search system 100 uses the autonomous software agent system to seek to understand the context and background of a code base/repository to generate the index of the code repository discussed above. In some embodiments, the intelligent repository search system 100 uses the autonomous software agent system to extract contextual data from information provided by a user to generate the index using the code understanding model. To illustrate, the intelligent repository search system 100 uses the autonomous software agent system to parse through a code repository and generate abstraction summaries using the code understanding model and one or more additional artificial intelligence models (e.g., such as the LLM engine).

In some embodiments, the autonomous software agent system uses the AI layer 408 to ingest data from a code base and further utilizes the code understanding model to generate output predictions related to context of the code base. For example, the intelligent repository search system 100 uses the autonomous software agent system to connect to code repositories and creates knowledge inputs/suggestions based on processing the information in the code repository.

To illustrate, the autonomous software agent system can read through documentation/specifications and then distills that information into data that is relevant for the code understanding model of the autonomous software agent system. In addition, after generating the index of the code repository (e.g., and the wiki as discussed above), the intelligent repository search system 100 further stores the index in the data layer 406 and/or uses the DevOps and Monitoring layer 410 to monitor changes/thresholds related to the connected code repository.

Moreover, after generating the index of the code repository, the intelligent repository search system 100 further leverages the autonomous software agent system to generate response to prompts. In some embodiments, the intelligent repository search system 100 receives prompts from the frontend layer 402 submitted via the intelligent search interface (or where the intelligent repository search system 100 intakes prompt, whether via the web application, a messaging application, or otherwise) and are sent to the backend services 404 of the autonomous software agent system, where the prompt is processed by the one or more artificial intelligence components (e.g., Devin's brain).

As shown in FIG. 4, the intelligent repository search system 100 utilizes the client layer 400 to receive interactions. In particular, users can submit a prompt of a question regarding a code repository via a Devin Messaging Application Integration, an application programming interface call, or directly through a web browser application of the intelligent search interface. In some embodiments, the messaging application integration lets users prompt the intelligent repository search system 100 and to further create sessions by tagging a Devin Slackbot in their team's messaging server.

In some embodiments, as shown, the autonomous software agent system utilizes an LLM engine (e.g., a model that selects one or more large language models according to certain parameters/requirements) of an autonomous software agent to generate a response to a prompt. In particular, the autonomous software agent system calls a first large language model for a first task (e.g., generating a first result for a prompt) and a second large language model for a second task (generating a second result for the prompt).

In one or more embodiments, the intelligent repository search system 100 uses the autonomous software agent system which utilizes the complex architectural design shown in FIG. 4. In particular, the autonomous software agent system includes a natural language processing component (e.g., Devin's Brain) that allows the intelligent repository search system 100 to understand natural language descriptions (e.g., the functionalities of desired software programs). In some embodiments, the autonomous software agent system utilizes natural language processing to analyze natural language descriptions in a prompt and to extract key functionalities and requirements.

As mentioned above, in some embodiments, the intelligent repository search system 100 generates a response to the prompt and uses the context from the response to deploy an autonomous software agent. In some embodiments, the intelligent repository search system 100 uses the autonomous software agent system to spin up a development box, where each spun up development box contains knowledge and the autonomous software agent system from one session to another does not transfer the knowledge over to the next session. In some embodiments, knowledge is a form of “memory” that allows the autonomous software agent system to retrieve information based on specific triggers that might be relevant to the session. As also mentioned, this knowledge (depending on the trigger) is retrievable across all sessions.

As mentioned above, the intelligent repository search system 100 uses the autonomous software agent system which deploys autonomous software agents that have access to their own machines. In particular, for each new spun up session, the intelligent repository search system 100 uses the autonomous software agent system to spin up a new development box (e.g., sandbox) which includes a shell, an editor and a bowser. Moreover, the autonomous software agent system allows a development box to be customized in a user's workspace (e.g., Devin's Workspace), where the user can save a specific machine snapshot that Devin will use each time it spins up a new development box.

Furthermore, the intelligent repository search system 100 uses the autonomous software agent system to generate development boxes that are isolated virtual machines. In particular, the development boxes run on top of a custom hypervisor implemented to support the virtual machine technology. Moreover, the state of a run (e.g., deploying an autonomous software agent) can be rolled-back to an earlier point in time. In running back to an earlier point in time, the intelligent repository search system 100 uses the autonomous software agent system to roll back both the state of “Devin's brain” (e.g., the knowledge and the progress on a certain task), as well as the state of Devin's machine (e.g., the machine contents).

Moreover, in some embodiments, the intelligent repository search system 100 uses the autonomous software agent system which offers a virtual private cloud (VPC) deployment solution that allows development boxes to run within a customer's (a set of users) cloud tenant with the “Devin brain” (e.g., a component of the autonomous software agent) interacting with the development boxes over a secure tunnel. All data related to sessions are stored at rest in the customer cloud tenant. Furthermore, each of these development boxes (or sessions) can speak to the customer-hosted services (connected via API integrations).

Further, as already mentioned, the autonomous software agent system includes machine learning models. In particular, the autonomous software agent system utilizes pre-trained machine learning models to translate descriptions (e.g., from a response to a prompt) into computer code. Moreover, the machine learning models utilized by the autonomous software agent system have been trained on vast amounts of computer code data, which allows them to identify patterns and generate functional code. In some embodiments, the autonomous software agent system utilizes the machine learning models to process the extracted information (e.g., key functionalities and requirements). In particular, the autonomous software agent system utilizes the machine learning models to search for patterns and identify similar code structures from their training data.

Additionally, the autonomous software agent system includes a code generation engine. In particular, based on processed information from the natural language processing and the machine learning models, the autonomous software agent system translates the descriptions into actual computer code. In other words, the output of the natural language processing and the machine learning model is pulled into the code generation engine to create viable computer code. In some embodiments, based on identified patterns, the autonomous software agent system utilizes the code generation engine to create functional code responsive to deploying an autonomous software agent after generating a response to a prompt.

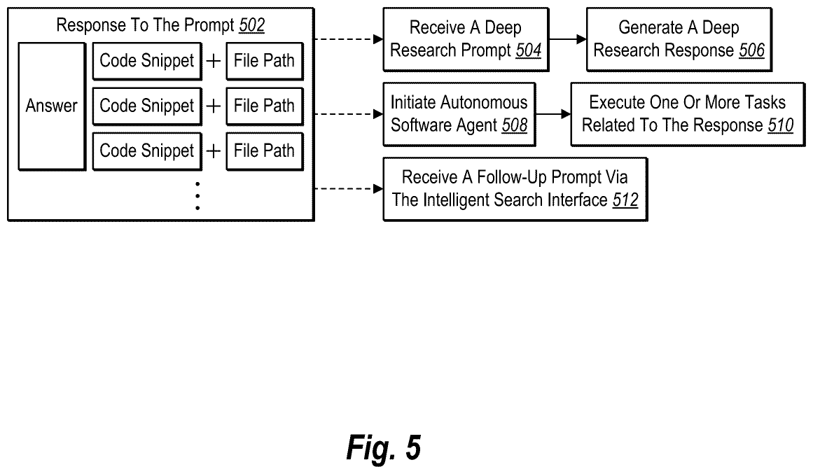

FIG. 4 describes how the intelligent repository search system 100 uses the autonomous software agent system to perform a variety of tasks such as generating an index of a code repository, searching the index of the code repository in response to a prompt, and deploying an autonomous software agent to execute one or more software coding tasks. FIG. 5 shows additional details of the intelligent repository search system 100 generating a response to a prompt and providing various downstream options in accordance with one or more embodiments.

As shown in FIG. 5, the intelligent repository search system 100 generates a response 502 to a prompt that includes an answer and various supporting sources (e.g., code snippets and file paths). After generating the response 502, the intelligent repository search system 100 can then receive a deep research prompt 504, receive a request to initiate an autonomous software agent 508, and/or receive a follow-up prompt 512 via the intelligent search interface.

In one or more embodiments, the deep research prompt 504 refers to a prompt to retrieve knowledge in a comprehensive, nuanced, and in-depth manner. In particular, the deep research prompt 504 is more than a simple question used to elicit a simple response, but rather, the deep research prompt 504 contains clear context, specific and multi-layered parts, and encourages responses that are thorough and scientific/evidence-based.

In one or more embodiments, the intelligent repository search system 100 receives the deep research prompt 504 which is based on the response 502, the contents of the response 502, and contextual data from the user of the computing device that submitted the prompt. In particular, the intelligent repository search system 100 receives the deep research prompt 504 based on a selection of a deep research element that is provided to the user of the computing device after generating the response 502. For example, the deep research prompt 504 can include instructions to perform chain-of-thought reasoning and to retrieve knowledge from external sources.

In one or more embodiments, the intelligent repository search system 100 utilizes advanced reasoning models (e.g., chain-of-thought reasoning models) to break down a deep research prompt/request into intermediate tasks. Due to the advanced reasoning capabilities that break down a task into discrete steps or subtasks, the intelligent repository search system 100 performs tasks at a higher level of accuracy and efficiency (e.g., relative to existing systems).

As shown in FIG. 5, the intelligent repository search system 100 can generate a deep research response 506 that is triggered by the deep research prompt 504. In particular, the deep research response 506 includes a thorough deep-dive into the index of the code repository (e.g., available to the autonomous software agent system) to generate a response. For example, the deep research response 506 is much more detail-oriented relative to the response 502 and contains extensive code snippets, file paths, and other supporting information responsive to the prompt submitted by the user. In some embodiments, the intelligent repository search system 100 draws from external systems to generate the deep research response 506.

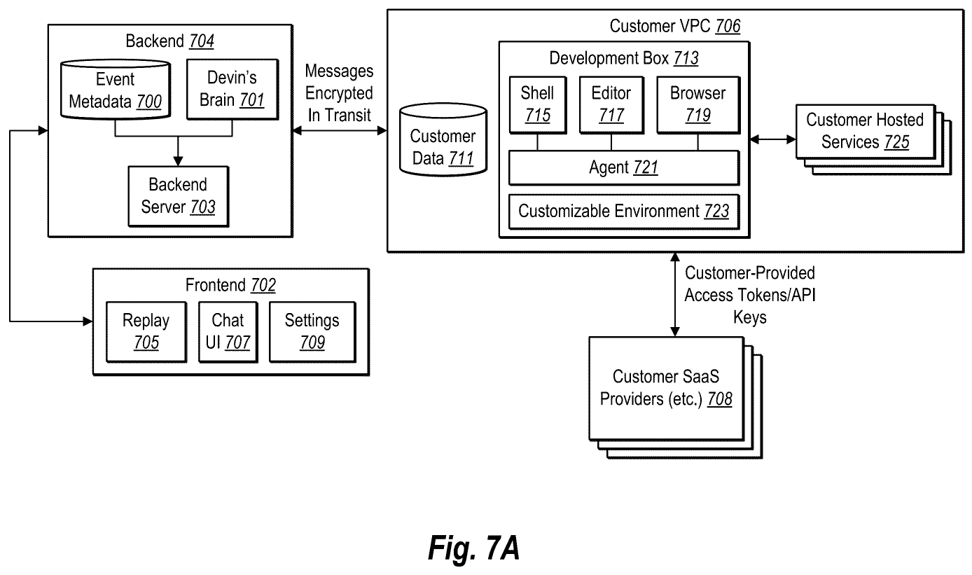

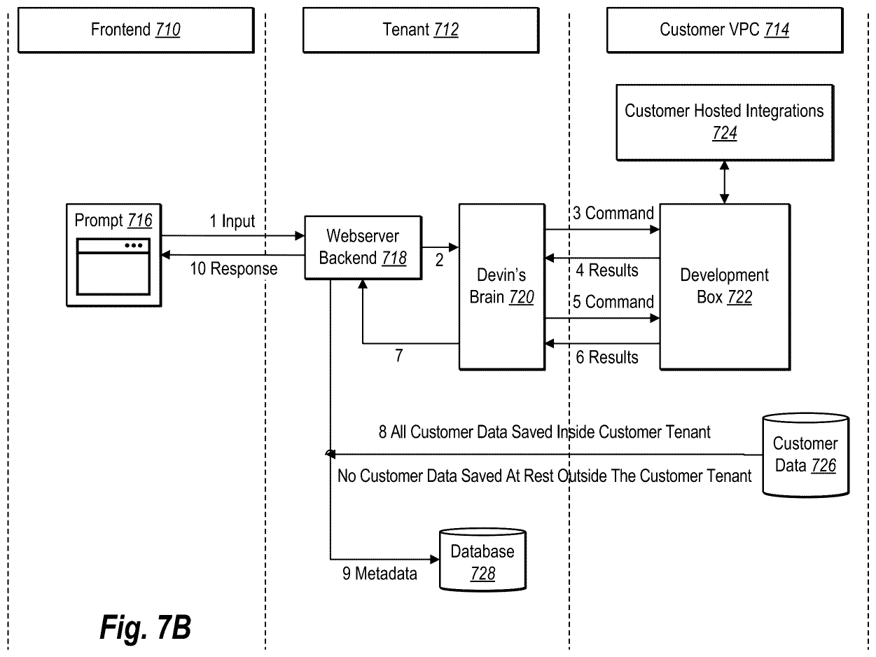

As shown in FIG. 5, the intelligent repository search system 100 also receives a request to initiate an autonomous software agent 508. In some embodiments, the intelligent repository search system 100 receives an indication from a user of the computing device to kick-off an autonomous software agent session. In particular, an autonomous software agent operates as an independent virtual machine computing device and is based on a unique artificial intelligence architecture shown above in FIG. 4 and in FIGS. 7A-7B.

To illustrate, in one or more embodiments, the intelligent repository search system 100 works with the autonomous software agent system to deploy an autonomous software agent to independently complete software development tasks such as writing computer code tests, adding features to an existing codebase, adding functionality to an existing codebase, developing prototypes, and building integrations between software applications (e.g., based on the context pulled together from the prompt submitted by the user of the computing device).

In particular, the intelligent repository search system 100 works with the autonomous software agent system to deploy an autonomous software agent that has access to its own virtual machine and the autonomous software agent is enabled to locally write computer code, test computer code, submit requests, and merge code into a codebase. In other words, the intelligent repository search system 100 works with the autonomous software agent system to deploy one or more software agents to independently perform a variety of non-trivial tasks, which enhances overall efficiency, accuracy, and operational flexibility of code development environments.

To illustrate, because of the search functionality provided via the intelligent search interface (e.g., which pulls together relevant context), the intelligent repository search system drastically improves the success rate and merge rate of the computer code generated by an autonomous software agent. In some embodiments, the intelligent repository search system 100 can draw from the response 502 and the context surrounding the response 502 to perform an act 510 of executing one or more software coding tasks related to the response 502 (e.g., using the autonomous software agent 508).

As also already mentioned, in some embodiments, the intelligent repository search system 100 receives the follow-up prompt 512. In one or more embodiments, the intelligent repository search system 100 provides the intelligent search interface which includes multi-turn functionality. For example, multi-turn functionality refers to the ability for the intelligent repository search system 100 to engage in multiple exchanges/turns of dialogue with a user of a computing device. For each turn, the intelligent repository search system 100 “remembers” and responds contextually to prior prompts, creating a more natural and dynamic conversation over multiple steps. Thus, as shown, the intelligent repository search system 100 receives the follow-up prompt 512 via the intelligent search interface and generates another response to the follow-up prompt 512.

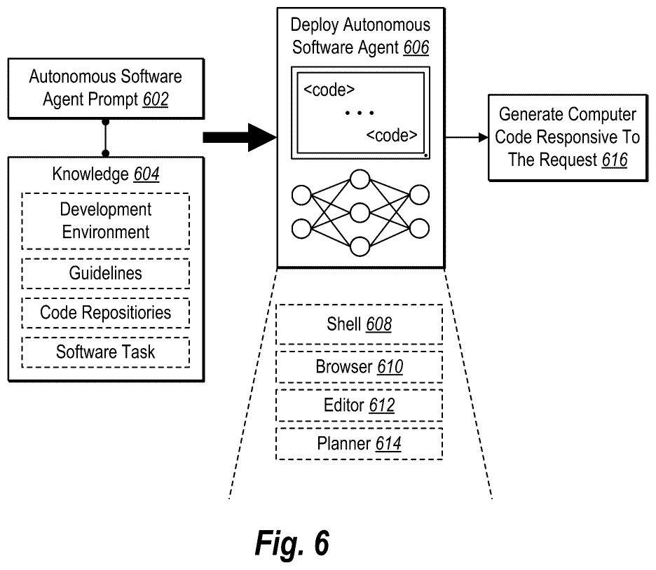

As discussed above, the intelligent repository search system 100 provides an option for a user of a computing device to kick-off a Devin session (e.g., deploy an autonomous software agent) after submitting a prompt and receiving a response to the prompt. FIG. 6 shows the intelligent repository search system 100 deploying an autonomous software agent after generating a response to a prompt with a question regarding a code repository in accordance with one or more embodiments.

FIG. 6 illustrates an overview of the intelligent repository search system 100 using the autonomous software agent system to generate computer code by deploying an autonomous software agent that is guided by the context of a response to a prompt submitted via the intelligent search interface. For example, FIG. 6 shows the autonomous software agent system accessing/receiving an autonomous software agent prompt 602.

In particular, the autonomous software agent prompt 602 refers to a natural language prompt (from a user of a computing device), an application programming interface call, and/or a tag/mention in a messaging application. In some embodiments, via an API, a user of a computing device can build custom workflows using an API of the autonomous software agent system and programmatically assign tasks for the autonomous software agent system to perform (e.g., after submitting one or more prompts via the intelligent search interface). Further, with the API, users of computing devices can essentially plug in the autonomous software agent system to any of their software development and internal tools.

In some embodiments, the intelligent repository search system 100 receives an indication (e.g., command+enter) to initiate an autonomous software agent. In particular, the intelligent repository search system 100 generates the autonomous software agent prompt 602 that includes the generated response to the prompt. In some embodiments, the autonomous software agent prompt 602 further includes source information from the generated response and additional contextual data.

In some embodiments, the autonomous software agent system can deploy an autonomous software agent in response to being tagged/mentioned in a messaging application. In particular, users of computing devices can tag the autonomous software agent system directly from conversations they're having with colleagues in the messaging application. Furthermore, the autonomous software agent system will reply directly in the messaging thread, and anyone can jump into the thread and provide further instructions (e.g., in addition the autonomous software agent prompt 602) to the autonomous software agent system.

As further shown in FIG. 6, the autonomous software agent system further accesses/receives knowledge 604. In particular, the knowledge 604 can include a development environment, guidelines, code repositories, and/or one or more software tasks. In particular, knowledge refers to a form of “memory” that allows the intelligent repository search system 100 to utilize the autonomous software agent system to retrieve information based on specific triggers that might be relevant to a session of the autonomous software agent. Further, the knowledge (depending on the trigger) is retrievable across all sessions. In some embodiments, users can specify conditions/triggers for when certain types of knowledge are available to an autonomous software agent.

To illustrate, the intelligent repository search system 100 uses the autonomous software agent system which utilizes a retrieval-augmented generation (RAG), which refers to retrieving relevant information from an external database or knowledge source. Further, RAG includes using a large language model to generate a response leveraging both the retrieved information and its own internal knowledge base. In particular, RAG includes an input query, information retrieval, and response generation.

As further shown in FIG. 6, the intelligent repository search system 100 uses the autonomous software agent system which further performs an act 606 of deploying an autonomous software agent (e.g., a cloned virtual machine that is isolated and can perform tasks siloed from other devices). In some embodiments, an autonomous software agent refers to an independent virtual machine computing device that generates and runs code in its own isolated environment.

In other words, the autonomous software agent exists independently of a computing device of a user who submitted a prompt to deploy the autonomous software agent and performs tasks based on knowledge that is provided to it. Moreover, as shown in FIG. 6, the intelligent repository search system 100 uses the autonomous software agent system to further provide to the autonomous software agent a shell 608, a browser 610, an editor 612, and a planner 614.

In other words, the intelligent repository search system 100 uses the autonomous software agent system to provide the autonomous software agent with its own software development environment to perform individualized tasks and not merely supplementary tasks (e.g., the autonomous software agent can deploy its own codebase by replicating an existing codebase, make changes, implement changes, run tests, etc.). In some embodiments, the autonomous software agent asks permission from a user prior to implementing and computer code changes.

Moreover, because the intelligent repository search system 100 typically has a thorough and nuanced understanding of a code repository and deploys the autonomous software agent after receiving a prompt about the code repository, the intelligent repository search system 100 generates more accurate and efficient computer code. As mentioned above, the intelligent repository search system 100 uses the autonomous software agent system to provide the combination of development tools to an autonomous software agent and outperforms existing methods due to its advanced reasoning capabilities. In particular, the autonomous software agent system utilizes an autonomous software agent with a chain-of-though reasoning model to break down meta-tasks into multiple intermediate tasks.

Furthermore, the autonomous software agent system uses the browser to obtain needed information (e.g., to browse blogs, documentation, etc.) responsive to intermediate tasks, uses the shell to make terminal calls (e.g., responsive to intermediate tasks), and further uses the editor to draft computer code (e.g., in an isolated environment) to accomplish each portion of a meta-task.

Thus, the combination of software development tools enables the advanced capabilities of an autonomous software agent. Accordingly, the intelligent repository search system 100 uses the autonomous software agent system which allows a user to perform non-trivial programming tasks using an autonomous software agent that can write, run, test, and deploy computer code (e.g., by initially pulling together relevant context for a software coding task via a prompt submitted to the intelligent search interface).

In some embodiments, the autonomous software agent includes one or more machine learning models, neural networks, and/or large language models. Thus, the intelligent repository search system 100 uses the autonomous software agent system to deploy an autonomous software agent that acts as an independent virtual machine computing device with various machine learning components used to analyze, process, and generate information.

In some embodiments, the shell 608 refers to a text-based interface where the intelligent repository search system 100 uses the autonomous software agent system to input commands that interact directly with a computer's operating system. In some embodiments, the browser 610 refers to an interface to that an autonomous software agent utilizes to browse documentation on the World Wide Web, tests web applications it builds, download/upload information, etc. Moreover, a user of a computing device can jump in to help the autonomous software agent navigate through browsing tasks via an interactive browser.

In some embodiments, the editor 612 refers to where the autonomous software agent writes computer code. In particular, the intelligent repository search system 100 uses the autonomous software agent system to allow a user to supervise, review and edit the computer code written by the autonomous software agent system. Further, in some embodiments, the planner 614 refers to a running “to do” list that is broken down and laid out by the autonomous software agent system in order to complete a task.

In particular, the planner 614 allows a user to visualize how the autonomous software agent deployed by the autonomous software agent system plans and thinks through solving a problem (e.g., in light of the context from the prompt and the response to the prompt). Furthermore, as shown in FIG. 6, the intelligent repository search system 100 uses the autonomous software agent system to further perform an act 616 of generating computer code responsive to the autonomous software agent prompt 602.

In some embodiments, computer code includes a set of instructions written in a programming language that a computing device can interpret and execute to perform a specific task. In particular, computer code includes a series of statements and functions that execute specific operations. Further, computer code includes statements written in specific syntax and translatable into machine code to be executed by a computing device.

Further, computer code can include function code and test code. As used herein, the term function code refers to a set of instructions written in a programming language that a computing device can interpret and execute to perform a specific task. Function code can include a series of statements and functions that define specific operations or processes performed by a computer upon execution of the code. In some cases, function code includes statements written in specific syntax and translatable into machine code to be executed by a computing device for performing one or more processes of an overall intent.

As used herein, the term test code refers to computer code that defines a function test for function code. For example, text code can include one or more code segments for determining that the function code satisfies an intent query. In some cases, the autonomous software agent system utilizes test code to test function code. For example, the intelligent repository search system 100 uses the autonomous software agent system to generate the test code that includes computer code for testing whether the output of function code satisfies an intent query. In some embodiments, test code can also test for different types of errors (e.g., syntax errors and logic errors) and/or for hazardous or harmful function code.

FIGS. 7A-7B illustrates additional details of the architecture of the autonomous software agent system in accordance with one or more embodiments. For example, FIG. 7A shows that for each session of deploying an autonomous software agent (e.g., after pulling together context from a prompt submitted to the intelligent search interface), the intelligent repository search system 100 uses the autonomous software agent system to spin up/deploy a Backend 704 that includes a “Devin brain container” paired with “Devin's development box” virtual machine. As mentioned above, Devin's Brain (e.g., the backend components of the autonomous software agent system) contains one or more machine learning/artificial intelligence models shown above in FIG. 4 used to process, analyze, and generate data.

As shown in FIG. 7A, the backend 704 includes event metadata 700 (e.g., context surrounding a prompt submitted to the intelligent search interface, a response to the prompt, or other external sources that contain contextual data), Devin's Brain 701 (e.g., one or more machine learning models shown and discussed in FIG. 4), and a backend server 703 (e.g., a server that handles logic, database interactions, authentication, and other services for deploying an autonomous software agent).

Further, FIG. 7A shows the backend interacting with a frontend 702 which includes replay 705 (e.g., a session replay that is a recording of previous user interactions with the intelligent repository search system 100), Chat UI 707 (e.g., the graphical user interface provided to a user to submit prompts), and settings 709 (e.g., custom settings established by the intelligent repository search system 100 or by a user).

Moreover, the backend 704 communicates with a Customer VPC 706 (e.g., a customer virtual private cloud, which is a dedicated and isolated virtual network within a public cloud service) via encrypted messages. In particular, FIG. 7A shows a development box 713 hosted on the Customer VPC 706 and the Customer VPC 706 further includes customer data 711.

Additionally, the development box 713 further includes a shell 715, an editor 717, a browser 719, an agent 721 (e.g., autonomous software agent), a customizable environment 723 (e.g., playbooks, knowledge, etc.) and customer hosted services 725 (e.g., services or applications hosted and managed by a tenant organization). Additionally, FIG. 7A shows that the Customer VPC 706 can integrate various applications via access tokens/API keys. In particular, the autonomous software agent system can use the development box 713 (e.g., the autonomous software agent) to write various code and make integrations with applications integrated with the Customer VPC 706 (e.g., customer SaaS providers 708).

Further, FIG. 7B shows that the autonomous software agent system receives a prompt 716 via a frontend 710. In response to the prompt 716, the intelligent repository search system 100 utilizes the autonomous software agent system to respond to the prompt 716 with a webserver backend 718 and further pass the information to Devin's Brain 720 (e.g., one or more artificial intelligence models shown above in FIG. 4).

As further shown in FIG. 7B, the autonomous software agent system passes commands/results back and forth between a Customer VPC 714 (e.g., a development box 722) and Devin's Brain 720. In other words, FIG. 7B illustrates the interaction between the frontend 710 of the autonomous software agent system, the backend of the autonomous software agent system, and an autonomous software agent deployed for performing tasks at the Customer VPC 714. Furthermore, the development box 722 also accesses customer hosted integrations 724 at the Customer VPC 714.

Additionally, FIG. 7B shows customer data 726 at the Customer VPC 714 which the intelligent repository search system 100 passes all customer data saved inside customer tenant to the tenant 712 (e.g., and no customer data is saved at rest outside the customer tenant). Moreover, FIG. 7B shows the intelligent repository search system 100 using the webserver backend 718 to pass metadata to a database 728.

In one or more embodiments, the intelligent repository search system 100 receives an autonomous software agent prompt and deploys an autonomous software agent, which includes one or more machine learning components (e.g., large language models). In one or more embodiments, the autonomous software agent system utilizes a text encoder to generate a set of text tokens for the autonomous software agent prompt.

Moreover, based on the text tokens, the intelligent repository search system 100 uses the autonomous software agent system to generate a plan (e.g., breaks down the software task), and further reasons how to complete one or more tasks. In particular, the autonomous software agent system uses a development box 722 to communicate with Devin's Brain 720 (e.g., the artificial intelligence components shown in FIG. 4) to determine which shell commands to make, computer code to write (e.g., in the editor), and webpages to browse.

In one or more embodiments, the intelligent repository search system 100 uses the autonomous software agent system which further utilizes a text encoder to process the autonomous software agent prompt. In particular, the text encoder includes a component of a neural network to transform textual data (e.g., the text prompt) into a numerical representation. For instance, the autonomous software agent system utilizes the text encoder to transform the autonomous software agent prompt into a text encoding (e.g., text tokens). Further, the autonomous software agent system utilizes the text encoder in a variety of ways.

For instance, the autonomous software agent system utilizes the text encoder to i) determine the frequency of individual words in the text prompt (e.g., each word becomes a feature vector), ii) determines a weight for each word within the text prompt to generate a text vector that captures the importance of words within a text prompt, iii) generates low-dimensional text vectors in a continuous vector space that represents words within the text prompt, and/or iv) generates contextualized text vectors by determining semantic relationships between words within the text prompt.

Furthermore, although not shown in FIGS. 4 and 7A-7B, in one or more embodiments, the intelligent repository search system 100 utilizes the autonomous software agent system to train Devin's Brain 720 (e.g., artificial intelligence components such as the code generation engine, the natural language processing, and the machine learning models). For example, the autonomous software agent system leverages a set of large language models and fine-tunes each large language model for different tasks. In particular, the autonomous software agent system has a large language model for terminal requests, a large language model for generating computer code, a large language model for generating a plan, and a large language model for determining which webpages to browse.

Moreover, the autonomous software agent system trains Devin's Brain by sending an input task to one or more of the large language models, generates a prediction for the input task, and compares the prediction with a ground truth reference. Based on the comparison, the autonomous software agent system fine-tunes or modifies parameters of one or more large language models (e.g., that are part of Devin's Brain). Thus, at inference time, the intelligent repository search system 100 utilizes the autonomous software agent system to perform advanced reasoning tasks fine-tuned for specific use cases.

In addition, as alluded to above, the autonomous software agent system trains machine learning models to translate descriptions into code. In some embodiments, the autonomous software agent system trains multiple machine learning models for discrete tasks. In particular, the autonomous software agent system trains a machine learning model to generate specific types of functional code. For example, the autonomous software agent system utilizes a machine learning model to generate computer code from a description and compares the description to a ground truth reference and fine-tunes/modifies parameters of the machine learning model.

Moreover, the autonomous software agent system further continuously learns from feedback and developer interactions. In particular, the autonomous software agent system deploys autonomous software agents that perform a variety of tasks, and in response to prompts and/or feedback, the autonomous software agent system learns from the interactions to improve its capabilities. In other words, the autonomous software agent system fine-tunes the artificial intelligence components in response to updates/feedback received from users.

FIGS. 7A-7B describe various architectural details of the autonomous software agent system. In particular, the architectural components of the autonomous software agent system allow the intelligent repository search system 100 to perform a variety of tasks. To illustrate, the autonomous software agent system performs repetitive coding tasks such as generating boilerplate code, data validation routines, and unit tests.

Moreover, the intelligent repository search system 100 uses the autonomous software agent system to perform code revies (e.g., one or more software developers examine code written by others to identify potential issues and provide feedback) and debugging such as analyzing code to identify potential bugs and suggesting fixes/improvements. Furthermore, the intelligent repository search system 100 uses the autonomous software agent system to perform deployment automation to automate a deployment process of software (e.g., streamlining the transition from development to production).

FIGS. 8A-8G illustrate a concrete example of the intelligent repository search system 100 providing rapid codebase understanding and diagnoses of a code repository in accordance with one or more embodiments. For example, FIG. 8A shows the intelligent repository search system 100 providing a graphical user interface 802 via a computing device 800. In particular, FIG. 8A shows that the graphical user interface 802 includes an option 804 for a user of a computing device to submit a prompt (e.g., ask Devin questions about your code).

In one or more embodiments, FIG. 8A shows that the intelligent repository search system 100 provides the graphical user interface 802 for a user of a computing device to initiate a search of a code repository. In particular, FIG. 8A shows a repository option 806 for a user of a computing device to indicate one or more code repositories connected to the autonomous software agent system. For example, the user of the computing device can choose from a dropdown list of connected code repositories and then further submit a text prompt in the option 804 that is a prompt to search the indicated one or more code repositories. As discussed above, in one or more embodiments, the intelligent repository search system 100 receives a submitted prompt and leverages the generated index of the one or more connected code repositories to generate a response to the submitted prompt.

Moreover, in some embodiments, FIG. 8A shows the intelligent repository search system 100 providing a deep research option 808, as discussed above in FIG. 5. In particular, the user of the computing device selects the deep research option 808 and further submit a text prompt (e.g., with the indicated one or more connected code repositories). In doing so, the intelligent repository search system 100 generates a deep research prompt in accordance with the principles discussed above.

Furthermore, FIG. 8A illustrates that the intelligent repository search system 100 provides (e.g., via the graphical user interface 802) an image option 810 for the user of the computing device to submit a visual prompt. In particular, the intelligent repository search system 100 can receive from the user of the computing device one or more images as part of a visual prompt. In some embodiments, the intelligent repository search system 100 can further receive a text prompt in addition to the visual prompt. Moreover, the intelligent repository search system 100 can respond to the user of the computing device with text and/or images. Accordingly, the image option 810 illustrates that the intelligent repository search system 100 utilizes multi-modality artificial intelligence models (e.g., multi-modal large language models) to process requests, and to further generate accurate responses to a user's prompt.

In one or more embodiments, the user of the computing device submits a prompt via the graphical user interface 802 and the intelligent repository search system 100 continues in a chat thread. In other words, the intelligent repository search system 100 provides the graphical user interface 802 for the user of the computing device to have a multi-turn conversation as discussed above. In particular, the user of the computing device can submit a prompt, and follow-up prompts to further refine a response generated by the intelligent repository search system 100. As described above, the multi-turn functionality allows the intelligent repository search system 100 to take context from each generated response to improve a subsequent response.

In some embodiments, in response to the user of the computing device submitting a prompt to the graphical user interface 802, the intelligent repository search system 100 can further transmit the prompt to a connected messaging application. In particular, users of computing devices (e.g., that are part of the connected messaging application) can view the ongoing chat thread/conversation via the graphical user interface 802. Furthermore, users of the computing device (e.g., part of the messaging application) can further join or chime into the conversation that is ongoing in the graphical user interface 802. In other words, anyone in the connected messaging application can jump into the thread and provide further prompts.

As described above, in some embodiments, the users connected to the messaging application can further take part of or all of the ongoing conversation in the graphical user interface 802 and cause the intelligent repository search system 100 to deploy an autonomous software agent.

In one or more embodiments, the user of the computing device can submit a prompt through the graphical user interface 802 shown in FIG. 8A and then the intelligent repository search system 100 causes the graphical user interface 802 to transition to a screen shown in FIG. 8B. For example, FIG. 8B shows the intelligent repository search system 100 turning “a half-baked idea” (e.g., not thoroughly planned out) into a concrete software debugging task. In particular, FIG. 8B shows how a web application has an issue of some input boxes handling Japanese inputs (e.g., typing) well but other input boxes not handling Japanese inputs well.

As shown in FIG. 8B, the intelligent repository search system 100 receives a prompt 812 that reads “how do we handle Japanese inputs when submitting input boxes?” Further, the intelligent repository search system 100 processes the prompt and generates a response 816 to the prompt that indicates that the web application handles Japanese inputs by checking isComposing on the received event (e.g., according to the code repository). In particular, FIG. 8B shows the response 816 of “You are asking about how Japanese text input (IME) is handled in the input components of the webapp, specifically in SimpleTextarea.tsx which is the core input component used across the application. From analyzing the code, I can see the following handling for Japanese (and other IME-based inputs . . . ”

Moreover, the right side of the interface shows the intelligent repository search system 100 also generates supporting sources 818 as part of generating the response 816. In particular, the supporting sources 818 show code snippets for isComposing and the corresponding file paths to access the code snippets in the code repository. Accordingly, in one or more embodiments, FIG. 8B illustrates how the intelligent repository search system 100 can receive prompts about computer code components used in multiple different places.

Further, the intelligent repository search system 100 can understand that there are those code components in multiple different places and provides each of those identified computer code components to the user of the computing device as part of the response. In other words, the intelligent repository search system 100 accurately identifies features used throughout a code repository and distills that information in an accurate and efficient manner to the user of the computing device.

In one or more embodiments, after receiving the submitted prompt from the user of the computing device, the intelligent repository search system 100 can further receive follow-up prompts (e.g., the account for the context from the previously submitted prompts and/or responses). Moreover, in some embodiments, the intelligent repository search system 100 can further deploy an autonomous software agent by generating an autonomous software agent prompt (e.g., discussed above in FIG. 5) based on the context of the generated response. In some embodiments, the intelligent repository search system 100 can receive a deep research request to dig a little further (e.g., based on the initially submitted prompt and response).

FIG. 8C shows an example of the intelligent repository search system 100 receiving a deep research prompt 820 (e.g., a selection of the deep research option 808 shown in FIG. 8A). In particular, FIG. 8C shows the deep research prompt 820 as “can you find all the input boxes which listen for enter but don't check isComposing?” In response to the deep research prompt 820, the intelligent repository search system 100 utilizes one or more machine learning models (e.g., chain-of-thought reasoning models and/or multi-modal large language models) to generate a deep research response 822.

For example, the deep research response shown in FIG. 8C shows “after analyzing the codebase, I've identified several input components that listen for the Enter key event but don't include a check for e.nativeEvent.isComposing in their implementation. This check is important for properly handling IME (Input Method Editor) composition events used for languages like Chinese, Japanese, and Korean . . . ” Moreover, FIG. 8C shows that the deep research response identifies that the “Onboarding Chatboat” and the “InlineFileSearch” components handle Enter key presses but do not check for composition. Additionally, the right side of FIG. 8C shows various code snippets and file paths that support the deep research response. In particular, FIG. 8C also shows copy-paste options 824a-824c, which allow a user of a computing device to copy one or more code snippets provided to the user of the computing device (e.g., as supporting sources for the deep research response 822).

FIG. 8D shows the intelligent repository search system 100 receiving an indication to hand a software coding task to the autonomous software agent system. In some embodiments, the intelligent repository search system 100 receives a selection (command+enter) of an autonomous agent selection and a further provides a pop-up 826 to construct a prompt for the autonomous software agent system (e.g., autonomous software agent prompt). In particular, FIG. 8D shows an option 828 to indicate which “code bugs” to fix based on the ongoing conversation with Devin. Moreover, FIG. 8D shows progress 830 of constructing a prompt to transmit to the autonomous software agent system.

Further, FIG. 8E shows the intelligent repository search system 100 generating a constructed prompt 834. In particular, the intelligent repository search system 100 utilizes context from the search (e.g., the prompt and the generated response via the intelligent search interface) to construct a detailed prompt for the autonomous software agent system. Moreover, FIG. 8E shows a submission option 832 to submit/edit the autonomous software agent prompt. In particular, the user of the computing device can click into the text box for the constructed prompt 834 and edit one or more of the shown elements.

FIG. 8E shows a task description of “add the missing ‘isComposing’ check to all input components that listen for the Enter key but don't currently implement the check. The proper implementation can be found in the Simpletextarea component . . . ” Further, FIG. 8E shows that the autonomous software agent prompt further includes components to fix such as the “Onboarding Chatbot . . . ” and the associated code with the Onboarding chatbot.

Moreover, FIG. 8F shows the intelligent repository search system 100 utilizing the autonomous software agent system to initiate an autonomous software agent to execute a software coding task 836 (e.g., debugging task) of fixing the isComposing element in the code repository. Furthermore, FIG. 8G shows the intelligent repository search system 100 utilizing the autonomous software agent system to generate a task description 838 and a detailed plan 840 that is responsive to the autonomous software agent prompt. In particular, FIG. 8G shows the intelligent repository search system 100 utilizing the autonomous software agent system to generate the detailed plan 840 that provides background, a task description, and the components in the code repository to fix.

In some embodiments, when a user starts a session, the intelligent repository search system 100 uses an autonomous software agent to make a plan for the session. In particular, the purpose of the plan is to make sure that the autonomous software agent stays on track. In some embodiments, the intelligent repository search system 100 causes the autonomous software agent to perform replanning. In particular, either when the autonomous software agent realizes that the regular is infeasible or if the user gives additional feedback when the autonomous software agent is working then the autonomous software agent system causes the autonomous software agent to replan.

In some embodiments, the intelligent repository search system 100 leverages an LLM or a combination of LLMs to generate a plan for an autonomous software agent. In some embodiments, the intelligent repository search system 100 further queries an LLM at various points to determine whether a plan is feasible. In particular, the intelligent repository search system 100 leverages an LLM to determine when the autonomous software agent is going off track, hits a dead end, a user interjects, etc., and generates a new plan.

To generate the plan shown in FIG. 8G, the intelligent repository search system 100 receives a prompt and uses a reasoning model to decompose the prompt into discrete tasks. In particular, the intelligent repository search system 100 performs advanced reasoning to analyze the prompt into a step-by-step process. For example, the intelligent repository search system 100 utilizes a chain of thought reasoning model to mimic human-like reasoning by breaking down the prompt/task into smaller, more manageable portions. In doing so, the intelligent repository search system 100 arrives at more accurate and logical conclusions when attempting to complete a task. In other words, the intelligent repository search system 100 utilizes a reasoning model to break down a meta-task into multiple sub-tasks (e.g., intermediate tasks), generates intermediate predictions, and provides explanations for each intermediate step.

Accordingly, in one or more embodiments, FIGS. 8A-8G illustrates how the intelligent repository search system 100 provides “scoping tools” for a user of a computing device to investigate the scope of a software coding/debugging task. In particular, the intelligent repository search system 100 provides the graphical user interface 802 as a way for a user of a computing device to accurately and efficiently obtain a clear indication of the magnitude of a coding task.

Further, the intelligent repository search system 100 provides tools for the user of the computing device to pull together instructions that can be provided to the autonomous software agent system, and downstream options that allow the user of the computing device to dig deeper. In other words, the intelligent repository search system 100 provides a framework for complex software tasks that are not initially well planned out by providing a workflow of starting with the graphical user interface 802 (e.g., to pull together context) and then deploying an autonomous software agent to execute a software coding task based on the pulled together context.

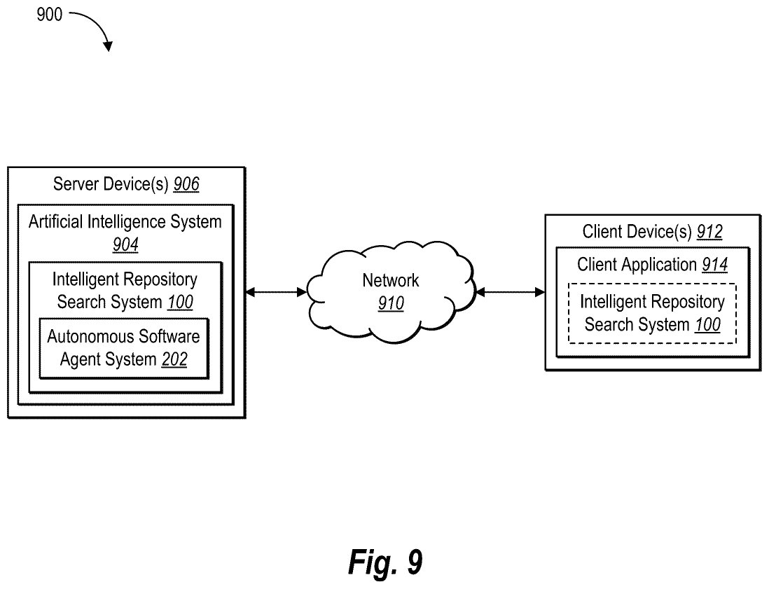

Additional details regarding the intelligent repository search system 100 will now be provided with reference to the figures. For example, FIG. 9 illustrates a schematic diagram of an exemplary system environment 900 in which the intelligent repository search system 100 operates. As illustrated in FIG. 9, the system environment 900 includes server device(s) 906, an artificial intelligence system 904, a network 910, and client device(s) 912. Additionally, FIG. 9 illustrates that the artificial intelligence system 904 includes the intelligent repository search system 100 and the intelligent repository search system 100 further includes the autonomous software agent system 202 (e.g., discussed above in FIGS. 2-8F).

Although the system environment 900 of FIG. 9 is depicted as having a particular number of components, the system environment 900 is capable of having a different number of additional or alternative components (e.g., a different number of servers, client devices, or other components in communication with the intelligent repository search system 100 via the network 910). Similarly, although FIG. 9 illustrates a particular arrangement of the server device(s) 906, the network 910, and the client device(s) 912, various additional arrangements are possible.

The server device(s) 906, the network 910, and the client device(s) 912 are communicatively coupled with each other either directly or indirectly (e.g., through the network 910 discussed in greater detail below). Moreover, the server device(s) 906 and the client device(s) 912 include one or more of a variety of computing devices (including one or more computing devices as discussed in greater detail below).

As mentioned above, the system environment 900 includes the server device(s) 906. In one or more embodiments, the server device(s) 906 process input for a request (e.g., a prompt to search a code repository and generate a response, a deep research prompt, a request to configure an autonomous software agent, and/or a request to deploy an autonomous software agent). In one or more embodiments, the server device(s) 906 comprise a data server. In some implementations, the server device(s) 906 comprise a communication server or a web-hosting server. Furthermore, the server device(s) 906 can be associated with the intelligent repository search system 100 or with a company that deploys the intelligent repository search system 100.

In some embodiments, the client device(s) 912 includes computing devices associated with the one or more user accounts that submit requests for the intelligent repository search system 100. In some embodiments, the intelligent repository search system 100 trains one or more artificial intelligence models such as a code understanding model, one or more large language models, and a code generation model.

In one or more embodiments, the client device(s) 912 includes smartphones, tablets, desktop computers, laptop computers, head-mounted-display devices, or other electronic devices. The client device(s) 912 includes one or more software applications (e.g., a client application 914) for generating content in accordance with the artificial intelligence system 904. In one or more embodiments, the client application 914 includes a software application hosted on the server device(s) 906 accessible by the client device(s) 912 through another application, such as a web browser.

To provide an example implementation, in some embodiments, the intelligent repository search system 100 on the server device(s) 906 supports the intelligent repository search system 100 on the client device(s) 912. For instance, in some cases, the intelligent repository search system 100 on the server device(s) 906 gathers data for the intelligent repository search system 100. In response, the intelligent repository search system 100, via the server device(s) 906, provides the information to the client device(s) 912. In other words, the client device(s) 912 obtains (e.g., downloads) the intelligent repository search system 100 (e.g., and the autonomous software agent system 202) from the server device device(s) 906 that is already trained/optimized. Once downloaded, the intelligent repository search system 100 on the client device(s) 912 is able to perform tasks (e.g., generative software tasks and/or respond to prompts) independent from the server device(s) 906. In one or more alternative implementations, the intelligent repository search system 100 generates or learns parameters for one or more artificial intelligence models (e.g., used to implement an autonomous software agent) in whole or in part on the client device(s) 912.

In alternative implementations, the intelligent repository search system 100 includes a web hosting application that allows the client device(s) 912 to interact with content and services hosted on the server device(s) 906. To illustrate, in one or more implementations, the client device(s) 912 accesses a software application supported by the server device(s) 906. In response, the artificial intelligence system 904 on the server device(s) 906 provides tools for monitoring/modifying/generating indexes, wikis, and/or computer code using the intelligent repository search system 100 via the autonomous software agent. In other words, the client device(s) 912 does not have to download the intelligent repository search system 100 while still being able to access/utilize the trained/optimized tools provided by the intelligent repository search system 100 via a web hosting application.

In some embodiments, the intelligent repository search system 100 is implemented in whole, or in part, by the individual elements of the system environment 900. For instance, although FIG. 9 illustrates the intelligent repository search system 100 implemented or hosted on the server device(s) 906, different components of the intelligent repository search system 100 are able to be implemented by a variety of devices within the system environment 900. For example, one or more (or all) components of the intelligent repository search system 100 are implemented by a different computing device or a separate server from the server device(s) 906. Indeed, as shown in FIG. 9, the client device(s) 912 includes the intelligent repository search system 100.

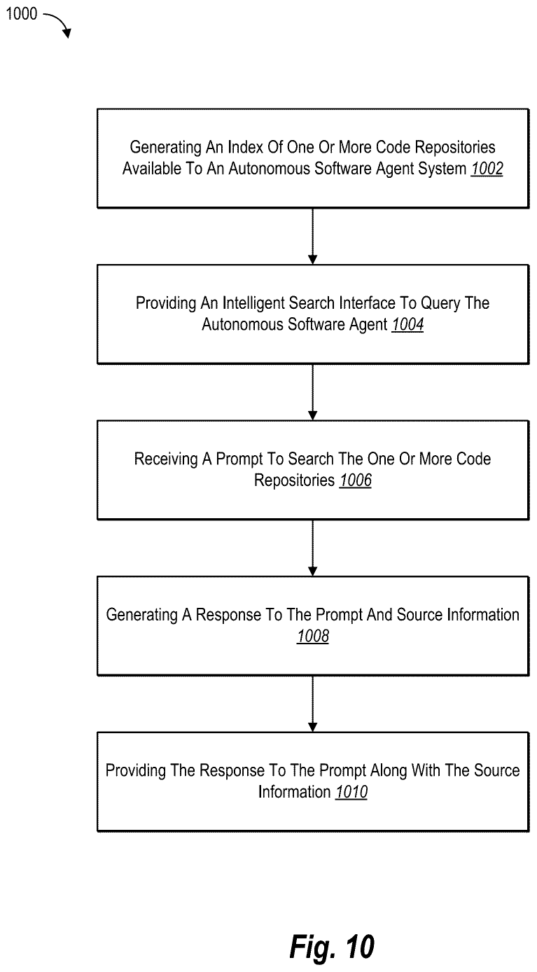

FIG. 10 illustrates a flowchart of a series of acts 1000 for generating a response to a prompt to search a code repository in accordance with one or more embodiments. FIG. 10 illustrates acts according to one embodiment, alternative embodiments may omit, add to, reorder, and/or modify any of the acts shown in FIG. 10. In some implementations, the acts of FIG. 10 are performed as part of a method. For example, in some embodiments, the acts of FIG. 10 are performed as part of a computer-implemented method. Alternatively, a non-transitory computer-readable medium stores instructions thereon that, when executed by at least one processor, cause a computing device to perform the acts of FIG. 10. In some embodiments, a system performs the acts of FIG. 10. For example, in one or more embodiments, a system includes at least one memory device. The system further includes at least one server device configured to cause the system to perform the acts of FIG. 10.

The series of acts 1000 includes an act 1002 of generating an index of one or more code repositories available to an autonomous software agent system. Further, the series of acts 1000 includes an act 1004 of providing an intelligent search interface to query the autonomous software agent. Moreover, the series of acts 1000 includes an act 1006 of receiving a prompt to search the one or more code repositories. Further, the series of acts 1000 includes an act 1008 of generating a response to the prompt and source information. Additionally, the series of acts 1000 includes an act 1010 of providing the response to the prompt along with the source information.

In particular, the act 1002 includes generating, utilizing one or more machine learning models, an index of one or more code repositories available to an autonomous software agent system. Further, the act 1004 includes providing, for display via a computing device, an intelligent search interface to query the autonomous software agent system about the one or more code repositories. Moreover, the act 1006 includes receiving a prompt via the intelligent search interface. Moreover, the act 1006 includes generating, by the autonomous software agent system utilizing the index of the one or more code repositories, a response to the prompt and source information from the one or more code repositories supporting the response. Additionally, the act 1008 includes generating, by the autonomous software agent system utilizing the index of the one or more code repositories, a response to the prompt and source information from the one or more code repositories supporting the response. Further, the act 1010 includes providing, for display in the intelligent search interface, the response to the prompt along with the source information from the one or more code repositories supporting the response.

In one or more embodiments, the series of acts 1000 includes generating the index of the one or more code repositories comprises generating system architecture diagrams, computer code documentation, and computer code conventions of the one or more code repositories available to the autonomous software agent system. In addition, in one or more embodiments, the series of acts 1000 includes receiving the prompt comprises receiving search instructions to identify specific features in the system architecture diagrams, the computer code documentation, and the computer code conventions of the one or more code repositories.

Further, in one or more embodiments, the series of acts 1000 includes analyzing, utilizing a plurality of search engines in tandem with the one or more machine learning models, the index of the one or more code repositories and additional contextual data to generate the response to the prompt, wherein the additional contextual data comprises code history, logging system data, ticketing system data, and chat application data. Further, in some embodiments, the series of acts 1000 includes generating code snippets and file paths that underpin the response to the prompt.

Moreover, in one or more embodiments, the series of acts 1000 includes receiving an indication to initiate an autonomous software agent from the autonomous software agent system after providing the response to the prompt along with the source information from the one or more code repositories supporting the response. Further, in some embodiments, the series of acts 1000 includes executing, utilizing the autonomous software agent, one or more software coding tasks related to the response.

Further, in one or more embodiments, the series of acts 1000 includes generating an autonomous software agent prompt comprising the response to the prompt, the source information, and additional contextual data, wherein the autonomous software agent prompt comprises instructions to the autonomous software agent system to execute one or more software coding tasks. Moreover, in one or more embodiments, the series of acts 1000 includes receiving an additional prompt from a user of a computing device utilizing the intelligent search interface. Further, in one or more embodiments, the series of acts 1000 includes receiving a deep research prompt from the user of the computing device utilizing the intelligent search interface, wherein the deep research prompt comprises a prompt to retrieve knowledge from external systems to generate a deep research response.

Further, in one or more embodiments, the series of acts 1000 includes generating, utilizing a multi-modal large language model as the one or more machine learning models to process the prompt and the index, a plurality of prompt embeddings and a plurality of index embeddings. Moreover, in one or more embodiments, the series of acts 1000 includes generating, utilizing a first search engine from a plurality of search engines, a first result from a subset of the plurality of prompt embeddings and a subset of the plurality of index embeddings.

Additionally, in one or more embodiments, the series of acts 1000 includes generating, utilizing a second search engine from the plurality of search engines, a second result from an additional subset of the plurality of prompt embeddings and an additional subset of the plurality of index embeddings. Further, in some embodiments, the series of acts 1000 includes generating the response to the prompt from the first result and the second result.

In one or more embodiments, the series of acts 1000 includes generating, utilizing one or more machine learning models, an index of one or more code repositories available to an autonomous software agent system. Moreover, in one or more embodiments, series of acts 1000 includes receiving, via an intelligent search interface, a prompt with a question for the autonomous software agent system regarding software code. In one or more embodiments, the series of acts 1000 includes generating, utilizing a plurality of search engines and the one or more machine learning models, a response to the prompt based on the index of the one or more code repositories and additional contextual data. In one or more embodiments, the series of acts 1000 includes providing, for display in the intelligent search interface, the response to the prompt along with relevant code snippets from the one more code repositories.

In addition, in one or more embodiments, the series of acts 1000 includes generating the response to the prompt and to further generate source information from the one or more code repositories supporting the response, wherein the source information comprises code snippets and file paths that underpin the response to the prompt. Further, in one or more embodiments, the series of acts 1000 includes receiving user input indicating a code snippet from the code snippets. Further, in some embodiments, the series of acts 1000 includes receiving an indication to initiate an autonomous software agent from the autonomous software agent system. In some embodiments, the series of acts 1000 includes generating an autonomous software agent prompt comprising the response to the prompt and the code snippet from the code snippets.

Moreover, in some embodiments, the series of acts 1000 includes execute, utilizing the autonomous software agent, one or more software coding tasks related to the response based on the autonomous software agent prompt. In one or more embodiments, the series of acts 1000 includes generating the index of the one or more code repositories by generating an abstraction summary of the one or more code repositories available to the autonomous software agent system. Furthermore, in one or more embodiments, the series of acts 1000 includes receiving the prompt by receiving search instructions to extract a plurality of code snippets based on the abstraction summary of the one or more code repositories. Moreover, in one or more embodiments, the series of acts 1000 includes analyzing, utilizing a plurality of search engines in tandem with the one or more machine learning models, the index of the one or more code repositories, code history, logging system data, ticketing system data, and chat application data to generate the response to the prompt, wherein the response to the prompt comprises information grounded in the one or more code repositories and information grounded in sources external to the one or more code repositories.

Moreover, in some embodiments, the series of acts 1000 includes receiving a deep research prompt from a user of a computing device utilizing the intelligent search interface, wherein the deep research prompt comprises a prompt with instructions to perform chain-of-thought reasoning and to retrieve knowledge from external systems to generate a deep research response.

In one or more embodiments, the series of acts 1000 includes generating, utilizing one or more machine learning models, an index of a code repository available to an autonomous software agent system. Furthermore, in one or more embodiments, the series of acts 1000 includes receiving, via an intelligent search interface, a prompt with a question for the autonomous software agent system regarding software code. Moreover, in one or more embodiments, the series of acts 1000 includes in response to the prompt, generating, by the autonomous software agent system utilizing the index of the code repository, a response to the prompt. In one or more embodiments, the series of acts 1000 includes providing, for display in the intelligent search interface, the response to the prompt along with source information supporting the response. In one or more embodiments, the series of acts 1000 includes in response to receiving an indication to initiate an autonomous software agent from the autonomous software agent system, executing, utilizing the autonomous software agent, one or more software coding tasks related to the response

In one or more embodiments, the series of acts 1000 includes generating the index of the code repository comprises generating visual diagrams of the code repository and textual computer code data pertinent to the code repository. In one or more embodiments, the series of acts 1000 includes receiving the prompt comprises receiving search instructions to extract specific features in the visual diagrams of the code repository and the textual computer code data pertinent to the code repository.

Moreover, in some embodiments, the series of acts 1000 includes generating, utilizing a multi-modal large language model as the one or more machine learning models to process the prompt and the index, a plurality of prompt embeddings and a plurality of index embeddings. Further, in some embodiments, the series of acts 1000 includes generating, utilizing a first search engine from a plurality of search engines to compare a subset of the plurality of prompt embeddings with a subset of the plurality of index embeddings in a multi-dimensional latent space, a first result.

Moreover, in some embodiments, the series of acts 1000 includes generating, utilizing a second search engine from the plurality of search engines to compare an additional subset of the plurality of prompt embeddings with an additional subset of the plurality of index embeddings in the multi-dimensional latent space, a second result. Additionally, in some embodiments, the series of acts 1000 includes generating the response to the prompt from the first result and the second result.

Moreover, in some embodiments, the series of acts 1000 includes generating an autonomous software agent prompt comprising the response to the prompt, the source information, and additional contextual data, wherein the autonomous software agent prompt comprises instructions to the autonomous software agent system to execute one or more software coding tasks, wherein the additional contextual data comprises code history, logging system data, ticketing system data, and chat application data. Furthermore, in some embodiments, the series of acts 1000 includes receiving an additional prompt from a user of a computing device utilizing the intelligent search interface, wherein the additional prompt from the user of the computing device comprises the prompt, the response to the prompt, and the source information as additional context

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed by a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multiprocessor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

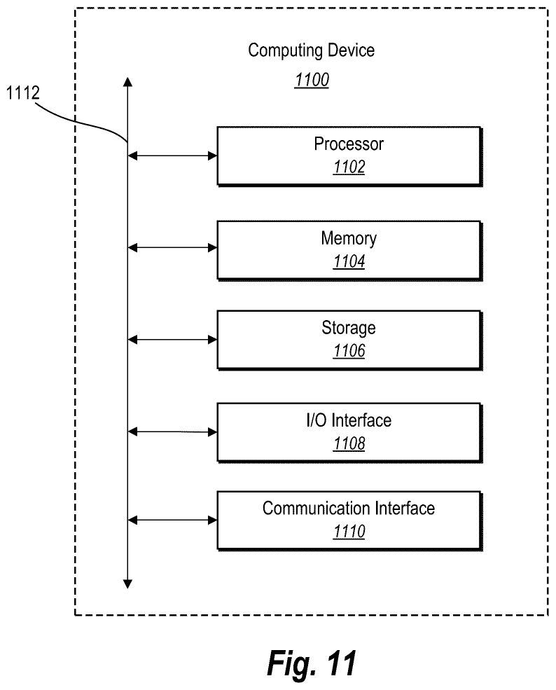

FIG. 11 illustrates a block diagram of an example computing device 1100 that may be configured to perform one or more of the processes described above. One will appreciate that one or more computing devices, such as the computing device 1100 may represent the computing devices described above (e.g., the server device(s) 906 and/or the client device(s) 912). In one or more embodiments, the computing device 1100 may be a mobile device (e.g., a mobile telephone, a smartphone, a PDA, a tablet, a laptop, a camera, a tracker, a watch, a wearable device). In some embodiments, the computing device 1100 may be a non-mobile device (e.g., a desktop computer or another type of client device). Further, the computing device 1100 may be a server device that includes cloud-based processing and storage capabilities.

As shown in FIG. 11, the computing device 1100 can include one or more processor(s) 1102, memory 1104, a storage device 1106, input/output interfaces 1108 (or “I/O interfaces 1108”), and a communication interface 1110, which may be communicatively coupled by way of a communication infrastructure (e.g., bus 1112). While the computing device 1100 is shown in FIG. 11, the components illustrated in FIG. 11 are not intended to be limiting. Additional or alternative components may be used in other embodiments. Furthermore, in certain embodiments, the computing device 1100 includes fewer components than those shown in FIG. 11. Components of the computing device 1100 shown in FIG. 11 will now be described in additional detail.

In particular embodiments, the processor(s) 1102 include hardware for executing instructions, such as those making up a computer program. As an example, and not by way of limitation, to execute instructions, the processor(s) 1102 may retrieve (or fetch) the instructions from an internal register, an internal cache, memory 1104, or a storage device 1106 and decode and execute them.

The computing device 1100 includes memory 1104, which is coupled to the processor(s) 1102. The memory 1104 may be used for storing data, metadata, and programs for execution by the processor(s). The memory 1104 may include one or more of volatile and non-volatile memories, such as Random-Access Memory (“RAM”), Read-Only Memory (“ROM”), a solid-state disk (“SSD”), Flash, Phase Change Memory (“PCM”), or other types of data storage. The memory 1104 may be internal or distributed memory.

The computing device 1100 includes a storage device 1106 including storage for storing data or instructions. As an example, and not by way of limitation, the storage device 1106 can include a non-transitory storage medium described above. The storage device 1106 may include a hard disk drive (HDD), flash memory, a Universal Serial Bus (USB) drive or a combination these or other storage devices.

As shown, the computing device 1100 includes one or more I/O interfaces 1108, which are provided to allow a user to provide input to (such as user strokes), receive output from, and otherwise transfer data to and from the computing device 1100. These I/O interfaces 1108 may include a mouse, keypad or a keyboard, a touch screen, camera, optical scanner, network interface, modem, other known I/O devices or a combination of such I/O interfaces 1108. The touch screen may be activated with a stylus or a finger.

The I/O interfaces 1108 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O interfaces 1108 are configured to provide graphical data to a display for presentation to a user. The graphical data may be representative of one or more graphical user interfaces and/or any other graphical content as may serve a particular implementation.

The computing device 1100 can further include a communication interface 1110. The communication interface 1110 can include hardware, software, or both. The communication interface 1110 provides one or more interfaces for communication (such as, for example, packet-based communication) between the computing device and one or more other computing devices or one or more networks. As an example, and not by way of limitation, communication interface 1110 may include a network interface controller (NIC) or network adapter for communicating with an Ethernet or other wire-based network or a wireless NIC (WNIC) or wireless adapter for communicating with a wireless network, such as a WI-FI. The computing device 1100 can further include a bus 1112. The bus 1112 can include hardware, software, or both that connects components of computing device 1100 to each other.

In the foregoing specification, the invention has been described with reference to specific example embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel to one another or in parallel to different instances of the same or similar steps/acts. The scope of the invention is, therefore, indicated by the appended claims rather than by the foregoing description. All changes that come within the meaning and range of equivalency of the claims are to be embraced within their scope.

1. A computer-implemented method comprising:
generating, utilizing one or more machine learning models and from one or more code repositories, system architecture diagrams, computer code documentation, and computer code conventions representing the one or more code repositories;
generating, utilizing the one or more machine learning models, a machine learning derived index of the one or more code repositories available to an autonomous software agent system, wherein the machine learning derived index comprises the system architecture diagrams, computer code documentation, and the computer code conventions that are representing the one or more code repositories;
providing, for display via a computing device, an intelligent search interface to query the autonomous software agent system comprising the one or more machine learning models about the one or more code repositories;
receiving a prompt via the intelligent search interface;
generating, by the autonomous software agent system utilizing the machine learning derived index of the one or more code repositories to identify code repository-specific context for the prompt, a response to the prompt and source information from the one or more code repositories supporting the response; and
providing, for display in the intelligent search interface, the response to the prompt along with the source information from the one or more code repositories supporting the response.

2. The computer-implemented method of claim 1, wherein:
receiving the prompt comprises receiving search instructions to identify specific features in the system architecture diagrams, the computer code documentation, and the computer code conventions of the one or more code repositories.

3. The computer-implemented method of claim 1, wherein generating the response to the prompt comprises:
analyzing, utilizing a plurality of search engines in tandem with the one or more machine learning models, the machine learning derived index of the one or more code repositories and contextual data to generate the response to the prompt,
wherein the contextual data comprises code history, logging system data, ticketing system data, and chat application data that is data in addition to the one or more code repositories.

4. The computer-implemented method of claim 1, wherein generating the source information from the one or more code repositories comprises generating code snippets and file paths that underpin the response to the prompt.

5. The computer-implemented method of claim 1, further comprising:
receiving an indication to initiate an autonomous software agent from the autonomous software agent system after providing the response to the prompt along with the source information from the one or more code repositories supporting the response; and
executing, utilizing the autonomous software agent, one or more software coding tasks related to the response.

6. The computer-implemented method of claim 5, wherein the indication to initiate the autonomous software agent from the autonomous software agent system comprises:
generating an autonomous software agent prompt comprising the response to the prompt, the source information, and contextual data,
wherein the autonomous software agent prompt comprises instructions to the autonomous software agent system to execute one or more software coding tasks,
wherein the one or more software coding tasks comprises modifying, generating, testing. or validating software code within the one or more code repositories based on the response.

7. The computer-implemented method of claim 1, further comprising:
receiving an additional prompt from a user of a computing device utilizing the intelligent search interface; or
receiving a deep research prompt from the user of the computing device utilizing the intelligent search interface, wherein the deep research prompt comprises a prompt to retrieve knowledge from external systems to generate a deep research response.

8. The computer-implemented method of claim 1, wherein generating, by the autonomous software agent system utilizing the machine learning derived index of the one or more code repositories, the response to the prompt comprises:
generating, utilizing a multi-modal large language model as the one or more machine learning models to process the prompt and the machine learning derived index, a plurality of prompt embeddings and a plurality of index embeddings;
generating, utilizing a first search engine from a plurality of search engines, a first result from a subset of the plurality of prompt embeddings and a subset of the plurality of index embeddings;
generating, utilizing a second search engine from the plurality of search engines, a second result from an additional subset of the plurality of prompt embeddings and an additional subset of the plurality of index embeddings; and
generating the response to the prompt from the first result and the second result.

9. A system comprising:
one or more memory devices; and
one or more processors coupled to the one or more memory devices, configured to cause the system to:
generate, utilizing one or more machine learning models, a machine learning derived index of one or more code repositories available to an autonomous software agent system;
receive, via an intelligent search interface, a prompt with a question for the autonomous software agent system regarding software code, wherein the prompt with the question comprises a request to compile features within the one or more code repositories;
generate a contextualized response, that is responsive to the question regarding the software code within the one or more code repositories by utilizing a plurality of search engines and the one or more machine learning models to identify code repository-specific context for the prompt, the machine learning derived index of the one or more code repositories, and contextual data in addition to the one or more code repositories; and
provide, for display in the intelligent search interface, the contextualized response to the prompt along with relevant code snippets from the one or more code repositories.

10. The system of claim 9, wherein the one or more processors are configured to cause the system to generate the contextualized response to the prompt and to further generate source information from the one or more code repositories supporting the contextualized response, wherein the source information comprises code snippets and file paths that underpin the contextualized response to the prompt.

11. The system of claim 10, wherein the one or more processors are configured to cause the system to:
receive user input indicating a code snippet from the code snippets;
receive an indication to initiate an autonomous software agent from the autonomous software agent system; and
generate an autonomous software agent prompt comprising the contextualized response to the prompt and the code snippet from the code snippets.

12. The system of claim 11, wherein the one or more processors are configured to cause the system to execute, utilizing the autonomous software agent, one or more software coding tasks related to the contextualized response based on the autonomous software agent prompt.

13. The system of claim 9, wherein the one or more processors are configured to cause the system to:
generate the machine learning derived index of the one or more code repositories by generating an abstraction summary of the one or more code repositories available to the autonomous software agent system; and
receive the prompt by receiving search instructions to extract a plurality of code snippets based on the abstraction summary of the one or more code repositories.

14. The system of claim 11, wherein the one or more processors are configured to cause the system to generate the contextualized response by:
analyzing, utilizing a plurality of search engines in tandem with the one or more machine learning models, the machine learning derived index of the one or more code repositories, code history, logging system data, ticketing system data, and chat application data to generate the contextualized response to the prompt,
wherein the contextualized response to the prompt comprises information grounded in the one or more code repositories and information grounded in sources external to the one or more code repositories.

15. The system of claim 10, wherein the one or more processors are configured to cause the system to receive a deep research prompt from a user of a computing device utilizing the intelligent search interface, wherein the deep research prompt comprises a prompt with instructions to perform chain-of-thought reasoning and to retrieve knowledge from external systems to generate a deep research response.

16. A non-transitory computer-readable medium storing executable instructions which, when executed by at least one processing device, cause the at least one processing device to perform operations comprising:
generating, utilizing one or more machine learning models, a machine learning derived index of a code repository available to an autonomous software agent system;
receiving, via an intelligent search interface, a prompt with a question for the autonomous software agent system regarding software code, wherein the prompt with the question comprises a request to compile features within the code repository;
in response to the prompt, generating, by the autonomous software agent system utilizing the machine learning derived index of the code repository and contextual data, a contextualized response to the prompt;
providing, for display in the intelligent search interface, the response to the prompt along with source information supporting the response;
receiving, via the intelligent search interface, an indication to deploy an autonomous software agent from the autonomous software agent system to execute one or more software coding tasks; and
executing, utilizing the autonomous software agent deployed by the autonomous software agent system, the one or more software coding tasks responsive to the contextualized response to the prompt, wherein the one or more software coding tasks comprises modifying, generating, testing, or validating software code within the code repository based on the contextualized response.

17. The non-transitory computer-readable medium of claim 16, wherein:
generating the machine learning derived index of the code repository comprises generating visual diagrams of the code repository and textual computer code data pertinent to the code repository; and
receiving the prompt comprises receiving search instructions to extract specific features in the visual diagrams of the code repository and the textual computer code data pertinent to the code repository.

18. The non-transitory computer-readable medium of claim 16, generating the response to the prompt comprises:
generating, utilizing a multi-modal large language model as the one or more machine learning models to process the prompt and the machine learning derived index, a plurality of prompt embeddings and a plurality of index embeddings;
generating, utilizing a first search engine from a plurality of search engines to compare a subset of the plurality of prompt embeddings with a subset of the plurality of index embeddings in a multi-dimensional latent space, a first result;
generating, utilizing a second search engine from the plurality of search engines to compare an additional subset of the plurality of prompt embeddings with an additional subset of the plurality of index embeddings in the multi-dimensional latent space, a second result; and
generating the response to the prompt from the first result and the second result.

19. The non-transitory computer-readable medium of claim 16, wherein the operations further comprise:
generating an autonomous software agent prompt comprising the response to the prompt, the source information, and the contextual data,
wherein the autonomous software agent prompt comprises instructions to the autonomous software agent system to execute one or more software coding tasks,
wherein the contextual data comprises code history, logging system data, ticketing system data, and chat application data that is data in addition to the code repository.

20. The non-transitory computer-readable medium of claim 16, wherein the operations further comprise:
receiving an additional prompt from a user of a computing device utilizing the intelligent search interface,
wherein the additional prompt from the user of the computing device comprises the prompt, the response to the prompt, and the source information as additional context.
